(19) United States
(12) Patent Application Publication
(10) Pub. No.: US 2020/0270546 A1
(43) Pub. Date: Aug. 27, 2020

(54) FABRIC CARE COMPOSITIONS THAT INCLUDE GLYCERIDE POLYMERS

(71) Applicant: The Procter & Gamble Company, Cincinnati, OH (US)

(72) Inventors: Karunakaran NARASIMHAN, Mason, OH (US); Alyssa Catherine HOTALEN, Mason, OH (US); Neil Thomas FAIRWEATHER, Liberty Township, OH (US); Luke Andrew ZANNONI, West Chester, OH (US); Beth Ann SCHUBERT, Maineville, OH (US); Andrea DANNENBERG, Cincinnati, OH (US)

(21) Appl. No.: 16/790,778

(22) Filed: Feb. 14, 2020

(30) Foreign Application Priority Data
Feb. 21, 2019 (EP) 19158415.0

(51) Int. Cl. C11D 3/00; C11D 3/37; C11D 17/00; C11D 3/30

(52) U.S. Cl. CPC C11D 3/0015; C11D 3/30; C11D 17/0008; C11D 3/3746

(57) ABSTRACT

Fabric care compositions that include certain glyceride polymers, particularly those obtainable by certain processes, such as using olefin metathesis to oligomerize unsaturated glycerides. Processes of making and using such compositions, including processes of treating a fabric with such compositions.

### FIELD OF THE INVENTION

The present disclosure relates to fabric care compositions that include certain glyceride polymers. The present disclosure also relates to methods of making and using such compositions.

### BACKGROUND OF THE INVENTION

Branched-chain polyesters have a wide variety of applications. Their high molecular weight and low crystallinity makes them attractive for use in fabric care compositions. Such compounds are typically derived from certain short-chain dicarboxylic acids, such as adipic acid. Thus, such compounds may be unsuitable for certain applications, especially where it may be desirable that the polyester contain longer-chain hydrophobic portions.

A certain known method that includes the self-metathesis of natural oils (unsaturated fatty acid glycerides), such as soybean oil, provides one means of making branched-chain polyesters having longer-chain hydrophobic portions. But, using such methods, it is still difficult to obtain branched-chain polyester compositions having a higher molecular weight, such as molecular weights corresponding to oligomers containing, on average, about 5-6 triglycerides or more. Obtaining higher molecular-weight oligomers using such methods presents a number of difficulties, including practical limits on the time and the quality of the vacuum needed to remove the product olefins to drive the reaction toward making higher-molecular-weight oligomers.

Thus, while using self-metathesis of unsaturated fatty acid glycerides provides a useful means of obtaining branched-chain polyesters, there remains a continuing need to develop further processes that would allow for the practical synthesis of higher-weight glyceride oligomers.

### SUMMARY OF THE INVENTION

The present disclosure relates to fabric care compositions that include glyceride copolymers, for example glyceride copolymers made according to a certain process.

For example, the present disclosure relates to fabric care compositions that include an adjunct material, and a glyceride polymer obtainable by a process that includes the steps of: (a) providing a reaction mixture that includes unsaturated natural oil glycerides; (b) introducing a first quantity of a first olefin metathesis catalyst to the reaction mixture to react the unsaturated natural oil glycerides and form a first product mixture that includes unreacted unsaturated natural oil glycerides, first oligomerized unsaturated natural oil glycerides, and a first olefin byproduct; and (c) introducing a second quantity of a second olefin metathesis catalyst to the first product mixture to react the unreacted unsaturated natural oil glycerides and the first oligomerized unsaturated natural oil glycerides and form a second product mixture that includes second oligomerized unsaturated natural oil glycerides and a second olefin byproduct.

The present disclosure also relates to a fabric care compositions that include an adjunct material, and a glyceride polymer obtainable by a process that includes the steps of: (a) providing a reaction mixture comprising unsaturated natural oil glycerides, and, optionally, initial oligomerized unsaturated natural oil glycerides; (b) introducing a first quantity of a first olefin metathesis catalyst to the reaction mixture to react the unsaturated natural oil glycerides and, optionally, the initial oligomerized unsaturated natural oil glycerides, and form a first product mixture comprising unreacted unsaturated natural oil glycerides, first oligomerized unsaturated natural oil glycerides, and a first olefin byproduct; and (c) introducing a second quantity of a second olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct; where the method includes isomerizing the first oligomerized unsaturated natural oil glycerides.

The present disclosure also relates to a process of treating a fabric, where the process includes the steps of contacting a fabric with a composition according to the present disclosure (e.g., including the disclosed glyceride copolymers), optionally in the presence of water.

### BRIEF DESCRIPTION OF THE DRAWINGS

The figures herein are illustrative in nature and are not intended to be limiting.

FIG. 1 shows an exemplary process for making glyceride copolymers according to the present disclosure.

### DETAILED DESCRIPTION OF THE INVENTION

The present disclosure relates to fabric care compositions that include glyceride polymers. Such compositions can provide useful fabric care benefits, such as fabric enhancing benefits (e.g., fabric softness).

The glyceride polymers may be made by the processes of the present disclosure. It is believed that the processes of the present disclosure provide improved, more efficient ways to make the glyceride polymers, particularly at higher molecular weights. Furthermore, the glyceride polymers made from the presently described processes may have an improved odor profile compared to glyceride polymers made from known methods, making them more attractive for use in consumer products such as fabric care compositions. Additionally, the glyceride polymers of the present disclosure may be made from natural feedstocks, which may be desirable for sustainability/environmental reasons.

The compositions and processes of the present disclosure are described in more detail below.

As used herein, the articles “a” and “an” when used in a claim, are understood to mean one or more of what is claimed or described. As used herein, the terms “include,” “includes,” and “including” are meant to be non-limiting. The compositions of the present disclosure can comprise, consist essentially of, or consist of, the components of the present disclosure.

The terms “substantially free of” or “substantially free from” may be used herein. This means that the indicated material is at the very minimum not deliberately added to the composition to form part of it, or, preferably, is not present at analytically detectable levels. It is meant to include compositions whereby the indicated material is present only as an impurity in one of the other materials deliberately included. The indicated material may be present, if at all, at a level of less than 1%, or less than 0.1%, or less than 0.01%, or even 0%, by weight of the composition.

As used herein the phrase “fabric care composition” includes compositions and formulations designed for treating fabric. Such compositions include but are not limited to, laundry cleaning compositions and detergents, fabric softening/enhancing compositions, fabric freshening compositions, laundry prewash, laundry pretreat, laundry additives, spray products, dry cleaning agent or composition, laundry rinse additive, wash additive, post-rinse fabric treatment, ironing aid, unit dose formulation, delayed delivery formulation, compositions contained on or in a porous substrate or nonwoven sheet, and other suitable forms that may be apparent to one skilled in the art in view of the teachings herein. Such compositions may be used as a pre-laundering treatment, a post-laundering treatment, or may be added during the rinse or wash cycle of the laundering operation.

As used herein, “polymer” refers to a substance having a chemical structure that includes the multiple repetition of constitutional units formed from substances of comparatively low relative molecular mass relative to the molecular mass of the polymer. The term “polymer” includes soluble and/or fusible molecules having chains of repeat units, and also includes insoluble and infusible networks. As used herein, the term “polymer” can include oligomeric materials, which have only a few (e.g., 3-100) constitutional units

As used herein, “natural oil” refers to oils obtained from plants or animal sources. The terms also include modified plant or animal sources (e.g., genetically modified plant or animal sources), unless indicated otherwise. Examples of natural oils include, but are not limited to, vegetable oils, algae oils, fish oils, animal fats, tall oils, derivatives of these oils, combinations of any of these oils, and the like. Representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil. Representative non-limiting examples of animal fats include lard, tallow, poultry fat, yellow grease, and fish oil. Tall oils are by-products of wood pulp manufacture. In some embodiments, the natural oil or natural oil feedstock comprises one or more unsaturated glycerides (e.g., unsaturated triglycerides). In some such embodiments, the natural oil comprises at least 50% by weight, or at least 60% by weight, or at least 70% by weight, or at least 80% by weight, or at least 90% by weight, or at least 95% by weight, or at least 97% by weight, or at least 99% by weight of one or more unsaturated triglycerides, based on the total weight of the natural oil.

The term “natural oil glyceride” refers to a glyceryl ester of a fatty acid obtained from a natural oil. Such glycerides include monoacylglycerides, diacylglycerides, and triacylglyceriedes (triglycerides). In some embodiments, the natural oil glycerides are triglycerides. Analogously, the term “unsaturated natural oil glyceride” refers to natural oil glycerides, wherein at least one of its fatty acid residues contains unsaturation. For example, a glyceride of oleic acid is an unsaturated natural oil glyceride. The term “unsaturated alkenylized natural oil glyceride” refers to an unsaturated natural oil glyceride (as defined above) that is derivatized via a metathesis reaction with a short-chain olefin (as defined below). In some cases, olefinizing process shortens one or more of the fatty acid chains in the compound. For example, a glyceride of 9-decenoic acid is an unsaturated alkenylized natural oil glyceride. Similarly, butenylized (e.g., with 1-butene and/or 2-butene) canola oil is a natural oil glyceride that has been modified via metathesis to contain some short-chain unsaturated C₁₀-C₁₅ ester groups.

The term “oligomeric glyceride moiety” is a moiety comprising two or more (and up to 10, or up to 20) constitutional units formed via olefin metathesis from natural oil glycerides and/or alkenylized natural oil glycerides.

As used herein, “metathesis” refers to olefin metathesis. As used herein, “metathesis catalyst” includes any catalyst or catalyst system that catalyzes an olefin metathesis reaction.

As used herein, “metathesize” or “metathesizing” refer to the reacting of a feedstock in the presence of a metathesis catalyst to form a “metathesized product” comprising new olefinic compounds, i.e., “metathesized” compounds. Metathesizing is not limited to any particular type of olefin metathesis, and may refer to cross-metathesis (i.e., co-metathesis), self-metathesis, ring-opening metathesis, ring-opening metathesis polymerizations (“ROMP”), ring-closing metathesis (“RCM”), and acyclic diene metathesis (“ADMET”). In some embodiments, metathesizing refers to reacting two triglycerides present in a natural feedstock (self-metathesis) in the presence of a metathesis catalyst, wherein each triglyceride has an unsaturated carbon-carbon double bond, thereby forming a new mixture of olefins and esters which may include a triglyceride dimer. Such triglyceride dimers may have more than one olefinic bond, thus higher oligomers also may form. Additionally, in some other embodiments, metathesizing may refer to reacting an olefin, such as ethylene, and a triglyceride in a natural feedstock having at least one unsaturated carbon-carbon double bond, thereby forming new olefinic molecules as well as new ester molecules (cross-metathesis).

As used herein, “olefin” or “olefins” refer to compounds having at least one unsaturated carbon-carbon double bond. In certain embodiments, the term “olefins” refers to a group of unsaturated carbon-carbon double bond compounds with different carbon lengths. Unless noted otherwise, the terms “olefin” or “olefins” encompasses “polyunsaturated olefins” or “polyolefins,” which have more than one carbon-carbon double bond. As used herein, the term “monounsaturated olefins” or “mono-olefins” refers to compounds having only one carbon-carbon double bond. A compound having a terminal carbon-carbon double bond can be referred to as a “terminal olefin” or an “alpha-olefin,” while an olefin having a non-terminal carbon-carbon double bond can be referred to as an “internal olefin.” In some embodiments, the alpha-olefin is a terminal alkene, which is an alkene (as defined below) having a terminal carbon-carbon double bond. Additional carbon-carbon double bonds can be present.

The number of carbon atoms in any group or compound can be represented by the terms: “C_{z}”, which refers to a group of compound having z carbon atoms; and “C_{x-y}”, which refers to a group or compound containing from x to y, inclusive, carbon atoms. For example, “C₁₋₆ alkyl” represents an alkyl chain having from 1 to 6 carbon atoms and, for example, includes, but is not limited to, methyl, ethyl, n-propyl, isopropyl, isobutyl, n-butyl, sec-butyl, tert-butyl, isopentyl, n-pentyl, neopentyl, and n-hexyl. As a further example, a “C₄₋₁₀ alkene” refers to an alkene molecule having from 4 to 10 carbon atoms, and, for example, includes, but is not limited to, 1-butene, 2-butene, isobutene, 1-pentene, 1-hexene, 3-hexene, 1-heptene, 3-heptene, 1-octene, 4-octene, 1-nonene, 4-nonene, and 1-decene.

As used herein, the terms “short-chain alkene” or “short-chain olefin” refer to any one or combination of unsaturated straight, branched, or cyclic hydrocarbons in the C₂₋₁₄ range, or the C₂₋₁₂ range, or the C₂₋₁₀ range, or the C₂₋₈ range. Such olefins include alpha-olefins, wherein the unsaturated carbon-carbon bond is present at one end of the compound. Such olefins also include dienes or trienes. Such olefins also include internal olefins. Examples of short-chain alkenes in the C₂₋₆ range include, but are not limited to: ethylene, propylene, 1-butene, 2-butene, isobutene, 1-pentene, 2-pentene, 2-methyl-1-butene, 2-methyl-2-butene, 3-methyl-1-butene, cyclopentene, 1,4-pentadiene, 1-hexene, 2-hexene, 3-hexene, 2-methyl-1-pentene, 3-methyl-1-pentene, 4-methyl-1-pentene, 2-methyl-2-pentene, 3-methyl-2-pentene, 4-methyl-2-pentene, 2-methyl-3-pentene, and cyclohexene. Non-limiting examples of short-chain alkenes in the C₇₋₉ range include 1,4-heptadiene, 1-heptene, 3,6-nonadiene, 3-nonene, 1,4,7-octatriene. In certain embodiments, it is preferable to use a mixture of olefins, the mixture comprising linear and branched low-molecular-weight olefins in the C₄₋₁₀ range. In one embodiments, it may be preferable to use a mixture of linear and branched C₄ olefins (i.e., combinations of: 1-butene, 2-butene, and/or isobutene). In other embodiments, a higher range of C₁₁₋₁₄ may be used.

As used herein, “alkyl” refers to a straight or branched chain saturated hydrocarbon having 1 to 30 carbon atoms, which may be optionally substituted, as herein further described, with multiple degrees of substitution being allowed. Examples of “alkyl,” as used herein, include, but are not limited to, methyl, ethyl, n-propyl, isopropyl, isobutyl, n-butyl, sec-butyl, tert-butyl, isopentyl, n-pentyl, neopentyl, n-hexyl, and 2-ethylhexyl. The number of carbon atoms in an alkyl group is represented by the phrase “C_{x-y} alkyl,” which refers to an alkyl group, as herein defined, containing from x to y, inclusive, carbon atoms. Thus, “C₁₋₆ alkyl” represents an alkyl chain having from 1 to 6 carbon atoms and, for example, includes, but is not limited to, methyl, ethyl, n-propyl, isopropyl, isobutyl, n-butyl, sec-butyl, tert-butyl, isopentyl, n-pentyl, neopentyl, and n-hexyl. In some instances, the “alkyl” group can be divalent, in which case the group can alternatively be referred to as an “alkylene” group.

As used herein, “alkenyl” refers to a straight or branched chain non-aromatic hydrocarbon having 2 to 30 carbon atoms and having one or more carbon-carbon double bonds, which may be optionally substituted, as herein further described, with multiple degrees of substitution being allowed. Examples of “alkenyl,” as used herein, include, but are not limited to, ethenyl, 2-propenyl, 2-butenyl, and 3-butenyl. The number of carbon atoms in an alkenyl group is represented by the phrase “C_{x-y} alkenyl,” which refers to an alkenyl group, as herein defined, containing from x to y, inclusive, carbon atoms. Thus, “C₂₋₆ alkenyl” represents an alkenyl chain having from 2 to 6 carbon atoms and, for example, includes, but is not limited to, ethenyl, 2-propenyl, 2-butenyl, and 3-butenyl. In some instances, the “alkenyl” group can be divalent, in which case the group can alternatively be referred to as an “alkenylene” group.

As used herein, “mix” or “mixed” or “mixture” refers broadly to any combining of two or more compositions. The two or more compositions need not have the same physical state; thus, solids can be “mixed” with liquids, e.g., to form a slurry, suspension, or solution. Further, these terms do not require any degree of homogeneity or uniformity of composition. This, such “mixtures” can be homogeneous or heterogeneous, or can be uniform or non-uniform. Further, the terms do not require the use of any particular equipment to carry out the mixing, such as an industrial mixer.

Unless otherwise noted, all component or composition levels are in reference to the active portion of that component or composition, and are exclusive of impurities, for example, residual solvents or by-products, which may be present in commercially available sources of such components or compositions.

All temperatures herein are in degrees Celsius (° C.) unless otherwise indicated. Unless otherwise specified, all measurements herein are conducted at 20° C. and under the atmospheric pressure.

In all embodiments of the present disclosure, all percentages are by weight of the total composition, unless specifically stated otherwise. All ratios are weight ratios, unless specifically stated otherwise.

It should be understood that every maximum numerical limitation given throughout this specification includes every lower numerical limitation, as if such lower numerical limitations were expressly written herein. Every minimum numerical limitation given throughout this specification will include every higher numerical limitation, as if such higher numerical limitations were expressly written herein. Every numerical range given throughout this specification will include every narrower numerical range that falls within such broader numerical range, as if such narrower numerical ranges were all expressly written herein.

### Fabric Care Composition

The present disclosure relates to fabric care compositions that include certain glyceride polymers, which may be made according to the processes described below.

The fabric care composition may be a fabric enhancing composition. Such compositions may provide softness, conditioning, and/or freshness benefits to fabrics. The compositions may be intended to treat fabrics through the wash cycle and/or the rinse cycle of an automatic washing machine, preferably the rinse cycle. The fabric care composition may include less than 5%, or less than 2%, or less than 1%, or less than about 0.1%, by weight of the composition, of anionic surfactant, or even be substantially free of anionic surfactant.

The fabric care compositions of the present disclosure may be in any suitable form. The composition may be in the form of a liquid composition, a granular composition, a single-compartment pouch, a multi-compartment pouch, a dissolvable sheet, a pastille or bead, a fibrous article (which may be water-soluble or water-dispersible, or substantially non-soluble/non-dispersible), a tablet, a bar, a flake, a foam/mousse, a non-woven sheet (e.g., a dryer sheet), or a mixture thereof. The composition can be selected from a liquid, solid, or combination thereof. The composition may be in the form of a liquid fabric enhancer, a foam/mousse, a dryer sheet, or a pastille/bead.

The compositions of the present disclosure may have a pH of from about 2 to about 12, or from about 2 to about 7, or from about 2 to about 5. The pH of a composition is determined by dissolving/dispersing the composition in deionized water to form a solution at 10% concentration, at about 20° C.

### Glyceride Polymer

The fabric care compositions of the present disclosure contain certain glyceride polymers. It is believed that the glyceride polymers of the present disclosure may help to provide fabric care benefits, such as softness benefits. It is also believed that the glyceride polymers of the present disclosure are characterized by an improved odor profile compared to other glyceride polymers; without wishing to be bound by theory, it is believed that multiple catalyst additions favor conversion of polyunsaturated fatty acids of the glyceride copolymers to shorter chain monounsaturated fatty acids and lower molecular weight olefins. Temperature cycling induces isomerization, which when coupled with multiple catalyst additions favors conversion of polyunsaturated fatty acids to shorter chain monounsaturated fatty acids and lower molecular weight olefins. These lower molecular weight olefins are then more easily removed during the reaction process resulting in a higher molecular weight glyceride copolymer. These low molecular olefins, which if present can impart an unpleasant odor to the material, are more easily removed during and/or after the reaction process, thus resulting in an improved odor profile in the glyceride copolymer and resulting fabric care compositions.

The fabric care compositions of the present disclosure may include from about 0.1% to about 50%, or from about 0.5% to about 25%, or from about 1% to about 10%, or from about 2% to about 5%, by weight of the composition, of a glyceride polymer.

The glyceride polymers of the present disclosure may be obtained by certain processes and/or from certain feedstocks. These processes and feedstock materials are described in more detail below.

1. Methods Involving Batched Catalyst Introduction

In at least one aspect, the disclosure provides methods of forming a glyceride polymer, the methods comprising: (a) providing a reaction mixture comprising unsaturated natural oil glycerides; (b) introducing a first quantity of an olefin metathesis catalyst to the reaction mixture to react the unsaturated natural oil glycerides and form a first product mixture comprising unreacted unsaturated natural oil glycerides, first oligomerized unsaturated natural oil glycerides, and a first olefin byproduct; and (c) introducing a second quantity of the olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct.

A feature of such methods is the introduction of the olefin metathesis catalyst in two or more batches. Thus, in some embodiments, additional batches of olefin metathesis catalyst can be added. For example, in some embodiments, the second product mixture further comprises unreacted unsaturated natural oil glycerides, and further comprising introducing a third quantity of the olefin metathesis catalyst to the second product mixture to react the unreacted unsaturated natural oil glycerides and the second oligomerized unsaturated natural oil glycerides and form a third product mixture comprising third oligomerized unsaturated natural oil glycerides and a third olefin byproduct.

In the same way, a fourth batch of catalyst can be added. Thus, in some further embodiments, the third product mixture further comprises unreacted unsaturated natural oil glycerides, and further comprising introducing a fourth quantity of the olefin metathesis catalyst to the third product mixture to react the unreacted unsaturated natural oil glycerides and the third oligomerized unsaturated natural oil glycerides and form a fourth product mixture comprising fourth oligomerized unsaturated natural oil glycerides and a fourth olefin byproduct.

In the same way, a fifth batch of catalyst can be added. Thus, in some further embodiments, the fourth product mixture further comprises unreacted unsaturated natural oil glycerides, and further comprising introducing a fifth quantity of the olefin metathesis catalyst to the fourth product mixture to react the unreacted unsaturated natural oil glycerides and the fourth oligomerized unsaturated natural oil glycerides and form a fifth product mixture comprising fifth oligomerized unsaturated natural oil glycerides and a fifth olefin byproduct.

In the embodiments set forth in the preceding paragraphs, the amount of olefin metathesis catalyst can vary (or be the same) from one batch to the next. Thus, in some embodiments of the preceding embodiments, the weight-to-weight ratio of any two of the first quantity of the olefin metathesis catalyst, the second quantity of the olefin metathesis catalyst, the third quantity of the olefin metathesis catalyst, the fourth quantity of the olefin metathesis catalyst, and the fifth quantity of the olefin metathesis catalyst, ranges from 1:10 to 10:1, or from 1:5 to 5:1, or from 1:3 to 3:1, or from 1:2 to 2:1.

In general, the unsaturated natural oil glycerides are derived from one or more natural oils. In some further embodiments, the unsaturated natural oil glycerides are derived from one or more vegetable oils, such as seed oils. Any suitable vegetable oil can be used, including, but not limited to, rapeseed oil, canola oil (low erucic acid rapeseed oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, or any combination thereof. In some embodiments, the vegetable oil is canola oil.

Such seed vegetable oils may be fatty acid glycerides, where at least one of the hydroxyl groups on glycerin forms an ester with an unsaturated fatty acid. Such glycerides can be monoglycerides, diglycerides, triglycerides, or any combination thereof. The unsaturated fatty acid moiety can be one that occurs in nature (e.g., oleic acid), or, in some other examples, it can be one that is formed from alkenylizing an unsaturated fatty acid (e.g., 9-decenoic acid, which can be formed by reacting an alpha-olefin with a naturally occurring fatty acid, such as oleic acid). Thus, in some embodiments, the unsaturated natural oil glycerides comprise glycerides of unsaturated fatty acids selected from the group consisting of: oleic acid, linoleic acid, linolenic acid, vaccenic acid, 9-decenoic acid, 9-undecenoic acid, 9-dodecenoic acid, 9,12-tridecadienoic acid, 9,12-tetradecadienoic acid, 9,12-pentadecadienoic acid, 9,12,15-hexadecatrienoic acid, 9,12,15 heptadecatrienoic acid, 9,12,15-octadecatrienoic acid, 11-dodecenoic acid, 11-tridecenoic acid, and 11-tetradecenoic acid.

As noted above, the unsaturated natural oil glycerides can, in some embodiments, include unsaturated alkenylized natural oil glycerides. The unsaturated alkenylized natural oil glyceride is formed from the reaction of a second unsaturated natural oil glyceride with a short-chain alkene in the presence of a second metathesis catalyst. In some such embodiments, the unsaturated alkenylized natural oil glyceride has a lower molecular weight than the second unsaturated natural oil glyceride. Any suitable short-chain alkene can be used, according to the embodiments described above. In some embodiments, the short-chain alkene is a C₂₋₈ olefin, or a C₂₋₆ olefin. In some such embodiments, the short-chain alkene is ethylene, propylene, 1-butene, 2-butene, isobutene, 1-pentene, 2-pentene, 1-hexene, 2-hexene, or 3-hexene. In some further such embodiments, the short-chain alkene is ethylene, propylene, 1-butene, 2-butene, or isobutene. In some embodiments, the short-chain alkene is ethylene. In some embodiments, the short-chain alkene is propylene. In some embodiments, the short-chain alkene is 1-butene. In some embodiments, the short-chain alkene is 2-butene.

In embodiments where the unsaturated natural oil glycerides include unsaturated alkenylized natural oil glycerides, the unsaturated alkenylized natural oil glycerides can make up any suitable amount of the composition. In some embodiments, the unsaturated natural oil glycerides include at least 5 weight percent, or at least 10 weight percent, or at least 15 weight percent, or at least 20 weight percent, or at least 25 weight percent, each up to 50 weight percent, or 60 weight percent, or 70 weight percent, based on the total weight of the unsaturated natural oil glycerides in the composition.

Any suitable olefin metathesis catalyst can be used. In some embodiments, the olefin metathesis catalyst comprises an organoruthenium compound, an organoosmium compound, an organotungsten compound, an organomolybdenum compound, or any combination thereof. In some embodiments, the olefin metathesis catalyst comprises an organoruthenium compound.

Any suitable molecular weight can be achieved at each stage of the process. For example, in some embodiments, the second oligomerized unsaturated natural oil glycerides have a weight average molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the second oligomerized unsaturated natural oil glycerides have a higher molecular weight (M_{w}) than the first oligomerized unsaturated natural oil glycerides.

In some further embodiments, the third oligomerized unsaturated natural oil glycerides a molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the third oligomerized unsaturated natural oil glycerides have a higher molecular weight (M_{w}) than the second oligomerized unsaturated natural oil glycerides.

In some further embodiments, the fourth oligomerized unsaturated natural oil glycerides a molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the fourth oligomerized unsaturated natural oil glycerides have a higher molecular weight (M_{w}) than the third oligomerized unsaturated natural oil glycerides.

In some further embodiments, the fifth oligomerized unsaturated natural oil glycerides a molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol. In some such embodiments, the fifth oligomerized unsaturated natural oil glycerides have a higher molecular weight (M_{w}) than the fourth oligomerized unsaturated natural oil glycerides.

As noted above, the oligomerization process yields an olefin byproduct. In some instances, it may be desirable to remove at least a portion of this byproduct, for example, to drive the reaction to completion, to mitigate the risk of unwanted side reactions, and the like. Thus, in some embodiments of any of the aforementioned embodiments, one or more of the additional steps can be incorporated: removing at least a portion of the first olefin byproduct from the first product mixture, removing at least a portion of the second olefin byproduct from the second product mixture, removing at least a portion of the third olefin byproduct from the third product mixture, removing at least a portion of the fourth olefin byproduct from the fourth product mixture, and removing at least a portion of the fifth olefin byproduct from the fifth product mixture.

The removing can be carried out by any suitable means, such as venting the reactor, stripping procedures, etc. Various means of removing olefin byproducts are set forth in U.S. Patent Application Publication No. 2013/0344012, which disclosure is hereby incorporated by reference.

The olefin metathesis reactions can be carried out at any suitable temperature. In some embodiments, the olefin metathesis reactions that generate the first product mixture, the second product mixture, the third product mixture, the fourth product mixture, or the fifth product mixture, are carried out at a temperature of no more than 150° C., or no more than 140° C., or no more than 130° C., or no more than 120° C., or no more than 110° C., or no more than 100° C. In some such embodiments, the temperature of the reactor is maintained from one batch to the next. In some other instances, however, the reactor may be cooled to a lower temperature (e.g., room temperature) between steps.

The methods disclosed herein can include additional chemical and physical treatment of the resulting glyceride copolymers. For example, in some embodiments, the resulting glyceride copolymers are subjected to full or partial hydrogenation, such as diene-selective hydrogenation.

2. Processes Involving Isomerization

In at least one aspect, any one or more of the first oligomerized unsaturated natural oil glycerides, second oligomerized unsaturated natural oil glycerides, third oligomerized unsaturated natural oil glycerides, or fourth oligomerized unsaturated natural oil glycerides undergo an isomerization step.

The isomerizing can be carried out by any suitable means for isomerizing the olefinic bonds in unsaturated products. Suitable methods are set forth in U.S. Pat. No. 9,382,502, which is hereby incorporated by reference. For example, the isomerization step(s) may comprise comprise heating the first product mixture, the second product mixture, the third product mixture, and/or the fourth product mixture to a temperature of at least 150° C., or at least 155° C., or at least 160° C., or at least 165° C., or at least 170° C.

3. Derivation from Renewable Sources

The compounds employed in any of the aspects or embodiments disclosed herein can, in certain embodiments, be derived from renewable sources, such as from various natural oils or their derivatives. Any suitable methods can be used to make these compounds from such renewable sources.

Olefin metathesis provides one possible means to convert certain natural oil feedstocks into olefins and esters that can be used in a variety of applications, or that can be further modified chemically and used in a variety of applications. In some embodiments, a composition (or components of a composition) may be formed from a renewable feedstock, such as a renewable feedstock formed through metathesis reactions of natural oils and/or their fatty acid or fatty ester derivatives. When compounds containing a carbon-carbon double bond undergo metathesis reactions in the presence of a metathesis catalyst, some or all of the original carbon-carbon double bonds are broken, and new carbon-carbon double bonds are formed. The products of such metathesis reactions include carbon-carbon double bonds in different locations, which can provide unsaturated organic compounds having useful chemical properties.

A wide range of natural oils, or derivatives thereof, can be used in such metathesis reactions. Examples of suitable natural oils include, but are not limited to, vegetable oils, algae oils, fish oils, animal fats, tall oils, derivatives of these oils, combinations of any of these oils, and the like. Representative non-limiting examples of vegetable oils include rapeseed oil (canola oil), coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, and castor oil. Representative non-limiting examples of animal fats include lard, tallow, poultry fat, yellow grease, and fish oil. Tall oils are by-products of wood pulp manufacture. In some embodiments, the natural oil or natural oil feedstock comprises one or more unsaturated glycerides (e.g., unsaturated triglycerides). In some such embodiments, the natural oil feedstock comprises at least 50% by weight, or at least 60% by weight, or at least 70% by weight, or at least 80% by weight, or at least 90% by weight, or at least 95% by weight, or at least 97% by weight, or at least 99% by weight of one or more unsaturated triglycerides, based on the total weight of the natural oil feedstock.

The natural oil may include canola or soybean oil, such as refined, bleached and deodorized soybean oil (i.e., RBD soybean oil). Soybean oil typically includes about 95 percent by weight (wt %) or greater (e.g., 99 wt % or greater) triglycerides of fatty acids. Major fatty acids in the polyol esters of soybean oil include but are not limited to saturated fatty acids such as palmitic acid (hexadecanoic acid) and stearic acid (octadecanoic acid), and unsaturated fatty acids such as oleic acid (9-octadecenoic acid), linoleic acid (9,12-octadecadienoic acid), and linolenic acid (9,12,15-octadecatrienoic acid).

Such natural oils, or derivatives thereof, contain esters, such as triglycerides, of various unsaturated fatty acids. The identity and concentration of such fatty acids varies depending on the oil source, and, in some cases, on the variety. In some embodiments, the natural oil comprises one or more esters of oleic acid, linoleic acid, linolenic acid, or any combination thereof. When such fatty acid esters are metathesized, new compounds are formed. For example, in embodiments where the metathesis uses certain short-chain alkenes, e.g., ethylene, propylene, or 1-butene, and where the natural oil includes esters of oleic acid, an amount of 1-decene and 1-decenoid acid (or an ester thereof), among other products, are formed.

In some embodiments, the natural oil can be subjected to various pre-treatment processes, which can facilitate their utility for use in certain metathesis reactions. Useful pre-treatment methods are described in United States Patent Application Publication Nos. 2011/0113679, 2014/0275595, and 2014/0275681, all three of which are hereby incorporated by reference as though fully set forth herein.

In some embodiments, after any optional pre-treatment of the natural oil feedstock, the natural oil feedstock is reacted in the presence of a metathesis catalyst in a metathesis reactor. In some other embodiments, an unsaturated ester (e.g., an unsaturated glyceride, such as an unsaturated triglyceride) is reacted in the presence of a metathesis catalyst in a metathesis reactor. These unsaturated esters may be a component of a natural oil feedstock, or may be derived from other sources, e.g., from esters generated in earlier-performed metathesis reactions.

The conditions for such metathesis reactions, and the reactor design, and suitable catalysts are as described below with reference to the metathesis of the olefin esters. That discussion is incorporated by reference as though fully set forth herein.

4. Olefin Metathesis

In some embodiments, one or more of the unsaturated monomers can be made by metathesizing a natural oil or natural oil derivative. The terms “metathesis” or “metathesizing” can refer to a variety of different reactions, including, but not limited to, cross-metathesis, self-metathesis, ring-opening metathesis, ring-opening metathesis polymerizations (“ROMP”), ring-closing metathesis (“RCM”), and acyclic diene metathesis (“ADMET”). Any suitable metathesis reaction can be used, depending on the desired product or product mixture.

In some embodiments, after any optional pre-treatment of the natural oil feedstock, the natural oil feedstock is reacted in the presence of a metathesis catalyst in a metathesis reactor. In some other embodiments, an unsaturated ester (e.g., an unsaturated glyceride, such as an unsaturated triglyceride) is reacted in the presence of a metathesis catalyst in a metathesis reactor. These unsaturated esters may be a component of a natural oil feedstock, or may be derived from other sources, e.g., from esters generated in earlier-performed metathesis reactions. In certain embodiments, in the presence of a metathesis catalyst, the natural oil or unsaturated ester can undergo a self-metathesis reaction with itself.

In some embodiments, the metathesis comprises reacting a natural oil feedstock (or another unsaturated ester) in the presence of a metathesis catalyst. In some such embodiments, the metathesis comprises reacting one or more unsaturated glycerides (e.g., unsaturated triglycerides) in the natural oil feedstock in the presence of a metathesis catalyst. In some embodiments, the unsaturated glyceride comprises one or more esters of oleic acid, linoleic acid, linoleic acid, or combinations thereof. In some other embodiments, the unsaturated glyceride is the product of the partial hydrogenation and/or the metathesis of another unsaturated glyceride (as described above).

The metathesis process can be conducted under any conditions adequate to produce the desired metathesis products. For example, stoichiometry, atmosphere, solvent, temperature, and pressure can be selected by one skilled in the art to produce a desired product and to minimize undesirable byproducts. In some embodiments, the metathesis process may be conducted under an inert atmosphere. Similarly, in embodiments where a reagent is supplied as a gas, an inert gaseous diluent can be used in the gas stream. In such embodiments, the inert atmosphere or inert gaseous diluent typically is an inert gas, meaning that the gas does not interact with the metathesis catalyst to impede catalysis to a substantial degree. For example, non-limiting examples of inert gases include helium, neon, argon, methane, and nitrogen, used individually or with each other and other inert gases.

The reactor design for the metathesis reaction can vary depending on a variety of factors, including, but not limited to, the scale of the reaction, the reaction conditions (heat, pressure, etc.), the identity of the catalyst, the identity of the materials being reacted in the reactor, and the nature of the feedstock being employed. Suitable reactors can be designed by those of skill in the art, depending on the relevant factors, and incorporated into a refining process such, such as those disclosed herein.

The metathesis reactions disclosed herein generally occur in the presence of one or more metathesis catalysts. Such methods can employ any suitable metathesis catalyst. The metathesis catalyst in this reaction may include any catalyst or catalyst system that catalyzes a metathesis reaction. Any known metathesis catalyst may be used, alone or in combination with one or more additional catalysts. Examples of metathesis catalysts and process conditions are described in US 2011/0160472, incorporated by reference herein in its entirety, except that in the event of any inconsistent disclosure or definition from the present specification, the disclosure or definition herein shall be deemed to prevail. A number of the metathesis catalysts described in US 2011/0160472 are presently available from Materia, Inc. (Pasadena, Calif.).

In some embodiments, the metathesis catalyst includes a Grubbs-type olefin metathesis catalyst and/or an entity derived therefrom. In some embodiments, the metathesis catalyst includes a first-generation Grubbs-type olefin metathesis catalyst and/or an entity derived therefrom. In some embodiments, the metathesis catalyst includes a second-generation Grubbs-type olefin metathesis catalyst and/or an entity derived therefrom. In some embodiments, the metathesis catalyst includes a first-generation Hoveyda-Grubbs-type olefin metathesis catalyst and/or an entity derived therefrom. In some embodiments, the metathesis catalyst includes a second-generation Hoveyda-Grubbs-type olefin metathesis catalyst and/or an entity derived therefrom. In some embodiments, the metathesis catalyst includes one or a plurality of the ruthenium carbene metathesis catalysts sold by Materia, Inc. of Pasadena, Calif. and/or one or more entities derived from such catalysts. Representative metathesis catalysts from Materia, Inc. for use in accordance with the present teachings include but are not limited to those sold under the following product numbers as well as combinations thereof: product no. C823 (CAS no. 172222-30-9), product no. C848 (CAS no. 246047-72-3), product no. C601 (CAS no. 203714-71-0), product no. C627 (CAS no. 301224-40-8), product no. C571 (CAS no. 927429-61-6), product no. C598 (CAS no. 802912-44-3), product no. C793 (CAS no. 927429-60-5), product no. C801 (CAS no. 194659-03-9), product no. C827 (CAS no. 253688-91-4), product no. C884 (CAS no. 900169-53-1), product no. C833 (CAS no. 1020085-61-3), product no. C859 (CAS no. 832146-68-6), product no. C711 (CAS no. 635679-24-2), product no. C933 (CAS no. 373640-75-6).

In some embodiments, the metathesis catalyst includes a molybdenum and/or tungsten carbene complex and/or an entity derived from such a complex. In some embodiments, the metathesis catalyst includes a Schrock-type olefin metathesis catalyst and/or an entity derived therefrom. In some embodiments, the metathesis catalyst includes a high-oxidation-state alkylidene complex of molybdenum and/or an entity derived therefrom. In some embodiments, the metathesis catalyst includes a high-oxidation-state alkylidene complex of tungsten and/or an entity derived therefrom. In some embodiments, the metathesis catalyst includes molybdenum (VI). In some embodiments, the metathesis catalyst includes tungsten (VI). In some embodiments, the metathesis catalyst includes a molybdenum- and/or a tungsten-containing alkylidene complex of a type described in one or more of (a) Angew. Chem. Int. Ed. Engl., 2003, 42, 4592-4633; (b) Chem. Rev., 2002, 102, 145-179; and/or (c) Chem. Rev., 2009, 109, 3211-3226, each of which is incorporated by reference herein in its entirety, except that in the event of any inconsistent disclosure or definition from the present specification, the disclosure or definition herein shall be deemed to prevail.

In certain embodiments, the metathesis catalyst is dissolved in a solvent prior to conducting the metathesis reaction. In certain such embodiments, the solvent chosen may be selected to be substantially inert with respect to the metathesis catalyst. For example, substantially inert solvents include, without limitation: aromatic hydrocarbons, such as benzene, toluene, xylenes, etc.; halogenated aromatic hydrocarbons, such as chlorobenzene and dichlorobenzene; aliphatic solvents, including pentane, hexane, heptane, cyclohexane, etc.; and chlorinated alkanes, such as dichloromethane, chloroform, dichloroethane, etc. In some embodiments, the solvent comprises toluene.

In other embodiments, the metathesis catalyst is not dissolved in a solvent prior to conducting the metathesis reaction. The catalyst, instead, for example, can be slurried with the natural oil or unsaturated ester, where the natural oil or unsaturated ester is in a liquid state. Under these conditions, it is possible to eliminate the solvent (e.g., toluene) from the process and eliminate downstream olefin losses when separating the solvent. In other embodiments, the metathesis catalyst may be added in solid state form (and not slurried) to the natural oil or unsaturated ester (e.g., as an auger feed).

The metathesis reaction temperature may, in some instances, be a rate-controlling variable where the temperature is selected to provide a desired product at an acceptable rate. In certain embodiments, the metathesis reaction temperature is greater than −40° C., or greater than −20° C., or greater than 0° C., or greater than 10° C. In certain embodiments, the metathesis reaction temperature is less than 200° C., or less than 150° C., or less than 120° C. In some embodiments, the metathesis reaction temperature is between 0° C. and 150° C., or is between 10° C. and 120° C.

5. Exemplary Process of Making a Glyceride Copolymer

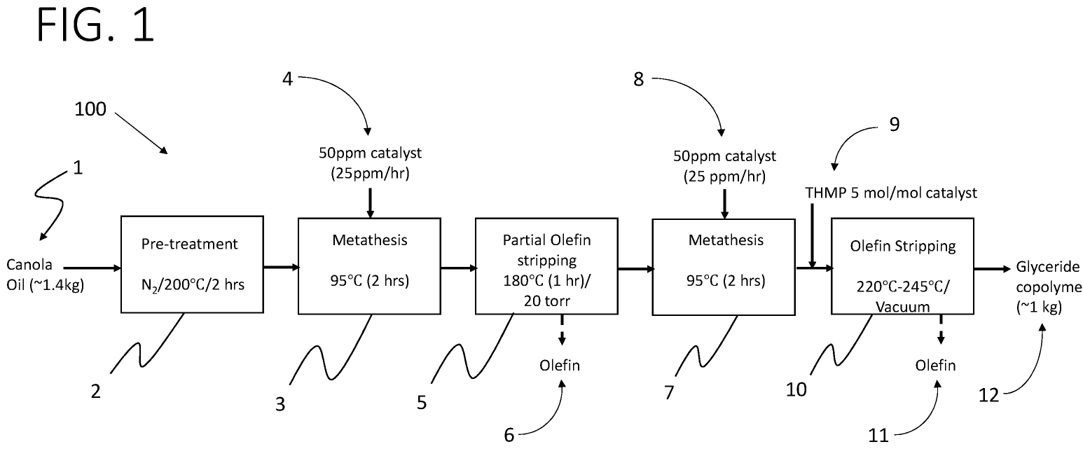

FIG. 1 shows an exemplary process for making glyceride copolymers according to the present disclosure. The process 100 starts with providing about 1.4 kg of canola oil 1. The oil 1 undergoes a pretreatment step 2, in which the oil 1 is treated under nitrogen gas (N₂) at 200° C. for about two hours. The pretreated oil undergoes a first metathesis step 3, where a catalyst 4 is added at about 25 ppm/hour for two hours, at 95° C. After the first metathesis step 3, there is a partial olefin stripping step 5, where the material is held for about 1 hour at a temperature of about 180° C. and a pressure of about 20 torr; olefins 6 are removed for about 1 hour. The remaining material undergoes a second metathesis step 7, where a catalyst 8 is added at about 25 ppm/hour for two hours, at 95° C. After the second metathesis step 7, about five moles of tris hydroxymethyl phosphine (“THMP”) 9 per one mole of catalyst is added, which sequesters/deactivates the catalyst. The resulting material undergoes another olefin stripping step 10, where the material is held at about 220-245° C. under vacuum, enabling the removal of additional olefins 11. The process 100 results in about 1 kg of glyceride copolymer 12.

### Adjunct Materials

The disclosed compositions may include additional adjunct materials, which may include: bleach activators, surfactants, delivery enhancing agents, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and/or perfume delivery systems, structure elasticizing agents, fabric conditioning actives (FCAs), anionic surfactant scavengers, carriers, hydrotropes, processing aids, structurants, anti-agglomeration agents, coatings, formaldehyde scavengers, deposition aids, emulsifiers, pigments, or mixtures thereof. Other embodiments of Applicants' compositions do not contain one or more of the listed adjuncts materials. The precise nature of these additional components, and levels of incorporation thereof (or even lack thereof), will depend on the physical form of the composition and the nature of the operation for which it is to be used.

The composition may include: from about 0.01% to about 50% of a fabric conditioning active; from about 0.001% to about 15% of an anionic surfactant scavenger; from about 0.01% to about 10%, of a delivery enhancing agent; from about 0.005% to about 30% of a perfume; from about 0.005% to about 30% of a perfume delivery system; from about 0.01% to about 20% of a soil dispersing polymer; from about 0.001% to about 10% of a brightener; from about 0.0001% to about 10% of a hueing dye; from about 0.0001% to about 10% of a dye transfer inhibiting agent; from about 0.01% to about 10% of an enzyme; from about 0.01% to about 20% of a structurant; from about 0.1% to about 80% of a builder; from about 0.1% to about 99% of a carrier; and/or mixtures thereof.

The fabric treatment compositions of the present disclosure may include a fabric conditioning active (FCA). The FCA may be present at a level of from about 1% to about 99%, by weight of the composition. The fabric treatment composition may include from about 1%, or from about 2%, or from about 3%, to about 99%, or to about 75%, or to about 50%, or to about 40%, or to about 30%, or to about 25%, or to about 20%, or to about 15%, or to about 10%, by weight of the composition, of FCA. The fabric treatment composition may include from about 5% to about 30%, by weight of the composition, of FCA.

Fabric conditioning actives (FCAs) suitable for compositions of the present disclosure may include quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof.

The composition may include a quaternary ammonium ester compound, a silicone, or combinations thereof, preferably a combination. The combined total amount of quaternary ammonium ester compound and silicone may be from about 5% to about 70%, or from about 6% to about 50%, or from about 7% to about 40%, or from about 10% to about 30%, or from about 15% to about 25%, by weight of the composition. The composition may include a quaternary ammonium ester compound and silicone in a weight ratio of from about 1:10 to about 10:1, or from about 1:5 to about 5:1, or from about 1:3 to about 1:3, or from about 1:2 to about 2:1, or about 1:1.5 to about 1.5:1, or about 1:1.

The composition may contain mixtures of different types of FCAs. The compositions of the present disclosure may contain a certain FCA but be substantially free of others. For example, the composition may be free of quaternary ammonium ester compounds, silicones, or both. The composition may comprise quaternary ammonium ester compounds but be substantially free of silicone. The composition may comprise silicone but be substantially free of quaternary ammonium ester compounds.

The composition may include perfume and/or a perfume delivery system. Suitable perfume delivery systems may include a Polymer Assisted Delivery (PAD) system, Molecule-Assisted Delivery (MAD) system, Cyclodextrin (CD) system, Starch Encapsulated Accord (SEA) system, Zeolite & Inorganic Carrier (ZIC) system, or mixtures thereof. A PAD system may include a resevoir system that includes perfume. Such a system may include a perfume delivery particle that may comprise a shell material and a core material, said shell material encapsulating said core material, which may include perfume. The shell may comprise material selected from the group consisting of polyethylenes; polyamides; polystyrenes; polyisoprenes; polycarbonates; polyesters; polyacrylates; aminoplasts, such as a polyurea (including polyoxymethyleneurea and/or melamine formaldehyde), polyurethane, and/or polyureaurethane; polyolefins; polysaccharide (e.g., alginate and/or chitosan); gelatin; shellac; epoxy resins; vinyl polymers; water insoluble inorganics; silicone; and mixtures thereof. The particle may include a deposition aid, for example as a coating; the deposition aid may comprise a cationic polymer.

The fabric treatment compositions of the present disclosure may include a structurant. Structurants may facilitate physical stability of the composition in a container, for example by suspending particles (e.g., of FCA droplets or encapsulated benefit agents) and/or inhibiting agglomeration/aggregation of such materials. Suitable structurants may include non-polymeric crystalline hydroxyl functional structurants (such as those derived from hydrogenated castor oil), polymeric structuring agents (including those derived from polyacrylates, as well as polymers, which may be relatively linear or cross-linked, derived from cationic monomers selected from the group consisting of methyl chloride quaternized dimethyl aminoethylammonium acrylate, methyl chloride quaternized dimethyl aminoethylammonium methacrylate and mixtures thereof, and non-ionic monomers selected from the group consisting of acrylamide, dimethyl acrylamide and mixtures thereof), cellulosic fibers (for example, microfibrillated cellulose, which may be derived from a bacterial, fungal, or plant origin, including from wood), di-amido gellants, or combinations thereof.

### Methods of Making Compositions

The compositions of the present invention can be formulated into any suitable form and prepared by any process chosen by the formulator, non-limiting examples of which are described in U.S. Pat. No. 5,879,584 which is incorporated herein by reference. For example, the glyceride copolymers can be combined directly with the composition's other ingredients without pre-emulsification and/or pre-mixing to form the finished products. Alternatively, the glyceride copolymers can be combined with surfactants or emulsifiers, solvents, suitable adjuncts, and/or any other suitable ingredients to prepare emulsions prior to compounding the finished products.

Suitable equipment for use in the processes disclosed herein may include continuous stirred tank reactors, homogenizers, turbine agitators, recirculating pumps, paddle mixers, plough shear mixers, ribbon blenders, vertical axis granulators and drum mixers, both in batch and, where available, in continuous process configurations, spray dryers, and extruders. Such equipment can be obtained from Lodige GmbH (Paderborn, Germany), Littleford Day, Inc. (Florence, Ky., U.S.A.), Forberg AS (Larvik, Norway), Glatt Ingenieurtechnik GmbH (Weimar, Germany), Niro (Soeborg, Denmark), Hosokawa Bepex Corp. (Minneapolis, Minn., U.S.A.), Arde Barinco (New Jersey, U.S.A.).

### Method of Use and Treated Fabric

Compositions disclosed herein can be used to clean and/or treat a fabric. Thus, the present disclosure further relates to a process of treating a fabric, the process comprising the steps of contacting a fabric with a composition according to the present disclosure, optionally in the presence of water. Typically at least a portion of the fabric is contacted with Applicant's disclosed composition, in neat form or diluted in a liquor, for example, a wash or rinse liquor, and then the fabric may be optionally washed and/or rinsed.

For purposes of the present invention, washing includes but is not limited to, scrubbing and/or mechanical agitation. The fabric may comprise most any fabric capable of being laundered or treated in normal consumer use conditions. Liquors that may comprise the disclosed compositions may have a pH of from about 3 to about 12. Such compositions are typically employed at concentrations of from about 500 ppm to about 15,000 ppm in solution. When the wash solvent is water, the water temperature typically ranges from about 5° C. to about 90° C. and, when the fabric comprises a fabric, the water to fabric ratio is typically from about 1:1 to about 30:1. The contacting step may occur during the wash and/or rinse cycle(s) of an automatic washing machine, preferably during a rinse cycle.

The present disclosure further relates to a fabric treated with any composition and/or glyceride polymer as disclosed herein.

### Combinations

Specifically contemplated combinations of the disclosure are herein described in the following lettered paragraphs. These combinations are intended to be illustrative in nature and are not intended to be limiting.

A. A fabric care composition comprising: an adjunct material, and a glyceride polymer obtainable by a process comprising the steps of: (a) providing a reaction mixture comprising unsaturated natural oil glycerides; (b) introducing a first quantity of a first olefin metathesis catalyst to the reaction mixture to react the unsaturated natural oil glycerides and form a first product mixture comprising unreacted unsaturated natural oil glycerides, first oligomerized unsaturated natural oil glycerides, and a first olefin byproduct; and (c) introducing a second quantity of a second olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct.

B. A fabric care composition comprising: an adjunct material, and a glyceride polymer obtainable by a process comprising the steps of: (a) providing a reaction mixture comprising unsaturated natural oil glycerides, and, optionally, initial oligomerized unsaturated natural oil glycerides; (b) introducing a first quantity of a first olefin metathesis catalyst to the reaction mixture to react the unsaturated natural oil glycerides and, optionally, the initial oligomerized unsaturated natural oil glycerides, and form a first product mixture comprising unreacted unsaturated natural oil glycerides, first oligomerized unsaturated natural oil glycerides, and a first olefin byproduct; and (c) introducing a second quantity of a second olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct; wherein the method comprises isomerizing the first oligomerized unsaturated natural oil glycerides.

C. The fabric care composition according to any one of paragraphs A or B, wherein second product mixture further comprises unreacted unsaturated natural oil glycerides, and further comprising introducing a third quantity of a third olefin metathesis catalyst to the second product mixture to react the unreacted unsaturated natural oil glycerides and the second oligomerized unsaturated natural oil glycerides and form a third product mixture comprising third oligomerized unsaturated natural oil glycerides and a third olefin byproduct, optionally, wherein the third product mixture further comprises unreacted unsaturated natural oil glycerides, and further comprising introducing a fourth quantity of a fourth olefin metathesis catalyst to the third product mixture to react the unreacted unsaturated natural oil glycerides and the third oligomerized unsaturated natural oil glycerides and form a fourth product mixture comprising fourth oligomerized unsaturated natural oil glycerides and a fourth olefin byproduct, optionally, wherein the fourth product mixture further comprises unreacted unsaturated natural oil glycerides, and further comprising introducing a fifth quantity of a fifth olefin metathesis catalyst to the fourth product mixture to react the unreacted unsaturated natural oil glycerides and the fourth oligomerized unsaturated natural oil glycerides and form a fifth product mixture comprising fifth oligomerized unsaturated natural oil glycerides and a fifth olefin byproduct.

D. The fabric care composition according to any one of paragraphs A-C, wherein the unsaturated natural oil glycerides comprise glycerides of unsaturated fatty acids selected from the group consisting of: oleic acid, linoleic acid, linolenic acid, vaccenic acid, 9-decenoic acid, 9-undecenoic acid, 9-dodecenoic acid, 9,12-tridecadienoic acid, 9,12-tetradecadienoic acid, 9,12-pentadecadienoic acid, 9,12,15-hexadecatrienoic acid, 9,12,15 heptadecatrienoic acid, 9,12,15-octadecatrienoic acid, 11-dodecenoic acid, 11-tridecenoic acid, and 11-tetradecenoic acid.

E. The fabric care composition according to any one of paragraphs A-D, wherein at least two of the first olefin metathesis catalyst, the second olefin metathesis catalyst, the third olefin metathesis catalyst if present, the fourth olefin metathesis catalyst if present, and/or the fifth olefin metathesis catalyst if present, are the same catalyst.

F. The fabric care composition according to any one of paragraphs A-E, wherein the unsaturated natural oil glycerides are derived from a natural oil, preferably derived from a vegetable oil, more preferably a vegetable oil selected from the group consisting of rapeseed oil, canola oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, or any combination thereof.

G. The fabric care composition according to any one of paragraphs A-F, wherein the glyceride polymer has a weight average molecular weight (M_{w}) ranging from 4,000 g/mol to 150,000 g/mol, or from 5,000 g/mol to 130,000 g/mol, or from 6,000 g/mol to 100,000 g/mol, or from 7,000 g/mol to 50,000 g/mol, or from 8,000 g/mol to 30,000 g/mol, or from 9,000 g/mol to 20,000 g/mol.

H. The fabric care composition according to any one of paragraphs A-G, further comprising one or more of: removing at least a portion of the first olefin byproduct from the first product mixture; removing at least a portion of the second olefin byproduct from the second product mixture; removing at least a portion of the third olefin byproduct from the third product mixture; removing at least a portion of the fourth olefin byproduct from the fourth product mixture; and/or removing at least a portion of the fifth olefin byproduct from the fifth product mixture.

I. The fabric care composition of any one of paragraphs A-H, wherein the olefin metathesis reaction(s) that generate the first product mixture, the second product mixture, the third product mixture, the fourth product mixture, and/or the fifth product mixture, are carried out at a temperature of no more than 180° C., or no more than 170° C., or no more than 160° C., or no more than 150° C., or no more than 140° C., or no more than 130° C., or no more than 120° C., or no more than 110° C., or no more than 100° C., and at vacuum conditions from about 10 to about 300 mm Hg.

J. The fabric care composition according to any one of paragraphs A-I, wherein the method further comprises at least one of: isomerizing the second oligomerized unsaturated natural oil glycerides; isomerizing the third oligomerized unsaturated natural oil glycerides; and/or isomerizing the fourth oligomerized unsaturated natural oil glycerides.

K. The fabric care composition according to any one of paragraphs A-J, wherein the isomerizing step(s) comprise heating the first product mixture, the second product mixture, the third product mixture, and/or the fourth product mixture to a temperature of at least 150° C., or at least 155° C., or at least 160° C., or at least 165° C., or at least 170° C., or at least 180° C., under vacuum conditions from about 10 to about 300 mm Hg.

L. The fabric care composition according to any one of paragraphs A-K, wherein the composition comprises from about 0.1% to about 50%, or from about 0.5% to about 25%, or from about 1% to about 10%, or from about 2% to about 5%, by weight of the composition, of the glyceride polymer.

M. The fabric care composition according to any one of paragraphs A-L, wherein the adjunct material is selected from: bleach activators, surfactants, delivery enhancing agents, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric conditioning actives (FCAs), anionic surfactant scavengers, carriers, hydrotropes, processing aids, structurants, anti-agglomeration agents, coatings, formaldehyde scavengers, pigments, a deposition aid, an emulsifier, and mixtures thereof.

N. The fabric care composition according to any one of paragraphs A-M, wherein the adjunct material is selected from at least one of the following: a) a fabric conditioning active (FCA), preferably an FCA selected from quaternary ammonium ester compounds, silicones, non-ester quaternary ammonium compounds, amines, fatty esters, sucrose esters, silicones, dispersible polyolefins, polysaccharides, fatty acids, softening or conditioning oils, polymer latexes, or combinations thereof, more preferably a quaternary ammonium ester compound, a silicone, or combinations thereof; b) perfume and/or a perfume delivery system, preferably a perfume delivery particle comprising a shell material and a core material, said shell material encapsulating said core material, preferably where said core material comprises perfume and said shell material comprises material selected from the group consisting of polyethylenes, polyamides, polystyrenes, polyisoprenes, polycarbonates, polyesters, polyacrylates, aminoplasts, polyolefins, polysaccharide, gelatin, shellac, epoxy resins, vinyl polymers, water insoluble inorganic materials, silicone, and mixtures thereof; and/or c) a structurant, preferably a structurant selected from non-polymeric crystalline hydroxyl functional structurants, polymeric structuring agents, cellulosic fibers, di-amido gellants, or combinations thereof.

O. The fabric care composition according to any one of paragraphs A-N, wherein the fabric care composition is in the form of a liquid composition, a granular composition, a single-compartment pouch, a multi-compartment pouch, a dissolvable sheet, a pastille, a fibrous article, a tablet, a bar, a flake, a foam, a non-woven sheet, or a mixture thereof, preferably a liquid composition.

P. The fabric care composition according to any one of paragraphs A-O, wherein the fabric care composition is a fabric enhancer composition, preferably a liquid fabric enhancer composition.

Q. A process of making a fabric care composition according to any one of paragraphs A-P, the process comprising the step of combining the adjunct material and the glyceride polymer.

R. A process of treating a fabric, the process comprising the steps of contacting a fabric with a fabric care composition according to any one of paragraphs A-P, optionally in the presence of water.

### Test Methods

z-Nose Measurement of LFE Headspace

All z-Nose experiments are carried out using the model 4200 vapor analysis system from Electronic Sensor Technology (Newbury Park, Calif.). The z-Nose operates at the speed of an electronic nose while delivering the precision and accuracy of a GC. The z-Nose consists of a sensor head, a support chassis, and a system controller housed within a small carrying case. The sensor head contains the hardware necessary to separate and detect the compounds in the analyte. The support chassis includes a small helium gas tank, power supply, and electronics to run the system using appropriate control systems. The analyzer is based on a single, uncoated quartz based surface acoustic wave sensor (SAW) with an uncoated piezoelectric quartz crystal that vibrates at a fundamental frequency. The crystal is in contact with the thermoelectric element, which controls the temperature for cooling during vapor adsorption and for heating during cleaning and operates by maintaining a highly focused and resonant surface acoustic wave at 500 MHz on its surface. Upon adsorption of the mass, the frequency of the surface acoustic wave will change in proportion to the adsorbant.

For z-Nose measurements, 2.00 g+/−0.01 g of liquid fabric enhancer (LFE) is transferred into a 40 mL vial (98 mm length and 28 mm o.d.) and sealed with a screw cap containing a septum (EP Scientific, VWR catalog number EP 140-CEP). The vials are kept at room temperature (˜22° C.) to allow the odor of the samples to equilibrate within the headspace of the vial for 20.5 h (+/−0.1 h). After equilibration, the samples are measured one by one with the z-Nose. The z-Nose uses a 5 cm needle at the inlet, which is used for sampling through the septa of the vials. The inlet temperature is 200° C., the valve temperature is 165° C., and the initial column temperature is 40° C. During analysis the column temperature is ramped at the rate of 10° C./s to a final column temperature of 200° C. The SAW sensor is operated at a temperature of 50° C. The trap is operated at a temperature of 250° C. A DB-5 column is used with a Helium flow rate of 3 cm³/min. The sampling mode (pumping time) is set to 10 s, followed by a 0.5 second injection and a 2 second wait time. The trap is fired, followed by a 1 second wait time, after which the column temperature is ramped to 200° C. at 10° C./s. Data is then acquired for 20 seconds. After this data sampling period, the system needs a 20 s baking period, in which the sensor is shortly heated to 150° C. and after which the temperature conditions of the inlet, column, and sensor are reset to their initial conditions. Between each sample measurement at least one blank of methanol is run to ensure proper cleaning of the system and a stable baseline. For each LFE, two replicate sample vials are prepared to give a total of two measurements per LFE.

The different chemical components in the gas sample are separated on the basis of their molecular weights and sequentially detected by the SAW detector through their frequency shift; and their different retention times are characterized by the Kovats index (KI). Without wishing to be bound by theory, the The Kovats index expresses the number of carbon atoms (multiplied by 100) of a hypothetical normal alkane which would have an adjusted retention volume (time) identical to that of the peak of interest when analyzed under identical conditions. For the Kovats index, a standard of homologic n-alkanes (here C6 to C14) is run at the beginning of each day as part of the z-Nose calibration procedure. These standard alkanes are indexed by multiplying the number of carbons in the alkane by 100. For example, the Kovats index of hexane is 600. The lower the Kovats index, the smaller and more volatile the molecule.

### Friction Measurement

Friction measurements are made on treated fabrics (e.g., fabrics that have been treated with an LFE product). For friction measurements, when drying of the fabrics is completed, all fabric terry washcloths are equilibrated for a minimum of 8 hours at 70±3.6° F. and 50%±5% Relative Humidity. Treated and equilibrated fabric washcloths are measured within 2 days of treatment. Treated fabrics are laid flat and stacked no more than 15 washcloths high while equilibrating. Friction measurements are all conducted under the same environmental conditions as the conditioning/equilibration step.

A Thwing-Albert FP2250/FP2255 Friction/Peel Tester with a 2 kilogram force load cell is used to measure fabric to fabric friction on terry washcloths (Thwing Albert Instrument Company, West Berlin, N.J.). The sled is a clamping style sled with a 6.4 by 6.4 cm footprint and weighs 200 grams (Thwing Albert Model Number 00225-218). A comparable instrument to measure fabric to fabric friction would be an instrument capable of measuring frictional properties of a horizontal surface. A 200 gram sled that has footprint of 6.4 cm by 6.4 cm and has a way to securely clamp the fabric without stretching it would be comparable. It is important, though, that the sled remains parallel to and in contact with the fabric during the measurement. The distance between the load cell to the sled is set at 10.2 cm. The crosshead arm height to the sample stage is adjusted to 25 mm (measured from the bottom of the cross arm to the top of the stage) to ensure that the sled remains parallel to and in contact with the fabric during the measurement. The following settings are used to make the measure:
T2 (Kinetic Measure): 10.0 sec
Total Time: 20.0 sec
Test Rate: 20.0 cm/min

The 11.4 cm×6.4 cm cut terry washcloth piece is attached to the clamping sled so that the face of the terry washcloth on the sled is pulled across the face of the terry washcloth on the sample plate. The sled is placed on the fabric and attached to the load cell. The crosshead is moved until the load cell registers between ˜1.0-2.0 gf. Then, it is moved back until the load reads 0.0 gf. At this point the measurement is made and the Kinetic Coefficient of Friction (kCOF) recorded. At this point the sled drag is commenced and the Kinetic Coefficient of Friction (kCOF) recorded at least every second during the sled drag. The kinetic coefficient of friction is averaged over the time frame starting at 10 seconds and ending at 20 seconds for the sled speed set at 20.0 cm/min For each treatment, at least ten replicate fabrics are measured.

### Molecular Weight

The examples below report the determination of molecular weight by gel permeation chromatography (GPC) for certain compositions containing glyceride copolymers. Weight-average molecular weight (M_{w}) values are determined using HPLC analysis of the resulting samples using a polystyrene calibration curve. In general, chloroform is used as the mobile phase.

Table 1 shows the molecular weights and the retention times of the polystyrene standards.

TABLE 1

| Standard Number | Average Reported MW | Retention Time (mm) |
|---|---|---|
| 1 | 150,000 | 19.11 |
| 2 | 100,000 | 19.63 |
| 3 | 70,000 | 20.43 |
| 4 | 50,000 | 20.79 |
| 5 | 30,000 | 21.76 |
| 6 | 9,000 | 23.27 |
| 7 | 5,000 | 23.86 |
| 8 | 1,000 | 27.20 |
| 9 | 500 | 28.48 |

### EXAMPLES

The following examples show certain illustrative embodiments of the compounds, compositions, and methods disclosed herein. These examples are not to be taken as limiting in any way. Nor should the examples be taken as expressing any preferred embodiments, or as indicating any direction for further research. Unless otherwise noted, chemicals used were ACS, reagent, or the standard grade available from Sigma-Aldrich.

### Example A—Self Metathesis with Batched Catalyst Introduction—30 L Scale

### Example A1—Batch Process with Overnight Hold and No THMP

Self-metathesized glyceride copolymer was prepared by charging canola oil (23 kg) to a 30 liter glass reactor. The canola oil was pre-treated by sparging with nitrogen while heating to 200° C. for a hold time of 2 hours. The canola oil was cooled to room temperature and stirred with nitrogen sparge overnight. The pre-treated canola oil was then heated to 95° C. under nitrogen sparge followed by the addition of a toluene solution of C827 metathesis catalyst (20 ppm catalyst relative to weight of oil) and stirring for 1 hour. An additional toluene solution of C827 metathesis catalyst (20 ppm catalyst relative to weight of oil—40 ppm total catalyst) was added followed by stirring for 1 hour. An additional toluene solution of C827 metathesis catalyst (10 ppm catalyst relative to weight of oil—50 ppm total catalyst) was added with stirring for 1 hour. The molecular weight after 5 hours (50 ppm catalyst) of the reaction was 11,013. The reaction was kept overnight at 95° C. under nitrogen sparge. The next morning an additional toluene solution of C827 metathesis catalyst (10 ppm catalyst relative to weight of oil—60 ppm total) was added followed by stirring for 1 hour. A 3.5 kg sample of glyceride copolymer with no THMP added was then taken. The reaction was cooled and discharged. Further details are set forth in Table 2 below.

### Example A2—Batch Process with Overnight Hold and THMP

The process of Example A1 was carried out as set forth above, except that before the final discharge, the reaction mixture was cooled to 80° C. followed by addition of THMP (5 molar equivalents relative to the total catalyst added less the catalyst removed with the 3.5 kg sample) and stirring for 2 hours. Further details are set forth in Table 2 below.

### Example A3—Batch Process with Overnight Hold and No THMP

The process of Example A1 was carried out as set forth above, except that the addition of THMP was not performed. The reaction was performed under nitrogen blanket. One hour after 50 ppm total catalyst was added an additional toluene solution of C827 metathesis catalyst (10 ppm catalyst relative to weight of oil—60 ppm total catalyst) was added. The molecular weight after 6 hours (60 ppm catalyst) of reaction was 10,912 Da. The reaction was left overnight at 95° C. under nitrogen blanket. The next morning an additional toluene solution of C827 metathesis catalyst (10 ppm catalyst relative to weight of oil—70 ppm total) was added followed by stirring for 1 hour. A 2.0 kg sample of glyceride copolymer with no THMP added was then taken. The reaction mixture was cooled to 80° C. and stirring for 2 hours. The reaction was cooled and discharged. Further details are set forth in Table 2 below.

### Example A4—Batch Process with Overnight Hold and THMP

The process of Example A3 was carried out as set forth above, except that before the final discharge, the reaction mixture was cooled to 80° C. followed by addition of THMP (5 molar equivalents relative to the total catalyst added less the catalyst removed with the 3.5 kg sample) and stirring for 2 hours. Further details are set forth in Table 2 below.

### Example A5—Batch Process with Overnight Hold and No THMP

Toluene solutions of C827 metathesis catalyst were added in doses of 20 ppm/20 ppm/10 ppm (relative to weight of oil) every 30 minutes. After one hour of stirring an additional toluene solution of C827 metathesis catalyst (10 ppm catalyst relative to weight of oil—60 ppm total catalyst) was added. The molecular weight after 8 hours of reaction was 11,106. The reaction was left overnight at 95° C. with nitrogen sparge. The next morning an additional toluene solution of C827 metathesis catalyst (10 ppm catalyst relative to weight of oil—70 ppm total) was added followed by stirring for 1 hour. The reaction was cooled and discharged. The yield was 0.77 kg glyceride copolymer/kg canola oil (after handling losses).

TABLE 2

| | | | Wipe Film | | |
|---|---|---|---|---|---|
| | | Total | Evaporator | | |
| | Reactor | catalyst | (“WFE”) | THMP | Final glyceride |
| Example | size | (ppm) | (Y/N) | added (Y/N) | copolymer Mw |
| A1 | 30 liter | 60 ppm | Y | N | 11,909 |
| A2 | 30 liter | 60 ppm | Y* | Y | 11,705 |
| A3 | 30 liter | 70 ppm | Y | N | 11,307 |
| A4 | 30 liter | 70 ppm | Y* | Y | 11,404 |
| A5 | 30 liter | 70 ppm | Y | N | 12,032 |

*Details regarding the olefin stripping via a wipe-film evaporator are provided below in Examples D2 and D3.

### Example B—Self Metathesis with Isomerization and Batched Catalyst Introduction

### Example B1—Batch Process with Heating/Cooling

Self-metathesized glyceride copolymer was prepared by charging canola oil to a 2 L liter glass reactor. The canola oil was pre-treated by sparging with nitrogen while heating to 200° C. for a hold time of 2 hours. The canola oil was cooled to room temperature and stirred with nitrogen sparge overnight. The pre-treated canola oil was then heated to 95° C. followed by the addition of a toluene solution of C827 metathesis catalyst (25 ppm catalyst relative to weight of oil). Vacuum was applied to 20 Torr with stirring for 1 hour. Vacuum was broken with an additional toluene solution of C827 metathesis catalyst (25 ppm catalyst relative to weight of oil—50 ppm total catalyst) followed by stirring under vacuum for 1 hour. The temperature of the reaction was raised to 180° C. with stirring for 1 hour under vacuum. The reaction was cooled to 95° C. under vacuum followed by the addition of a toluene solution of C827 metathesis catalyst (25 ppm catalyst relative to weight of oil—75 ppm total catalyst) and stirring for 1 hour followed by the addition of a toluene solution of C827 metathesis catalyst (25 ppm catalyst relative to weight of oil—100 ppm total catalyst) and stirring for 1 hour. The reaction was kept under a nitrogen sparge while cooling to room temperature overnight. The reaction mixture was warmed to 85° C. followed by addition of THMP (5 molar equivalents relative to the total catalyst added) and stirring for 2 hours. The reaction mixture was cooled and discharged into buckets. Further information is set forth in Table 3.

### Example B2—Batch Process with Heating/Cooling

The process of Example B1 was carried out as set forth above, except that catalyst was added dropwise by addition funnel, targeting ˜25 ppm/hour for a total of 100 ppm catalyst. Further information is set forth in Table 3.

### Example B3˜Batch Process with Heating/Cooling

The process of Example B1 was carried out as set forth above, except that experiment performed in 2 L kettle flask instead of 2 L round bottom. Further information is set forth in Table 3.

### Example B4˜Batch Process with Heating/Cooling

Self-metathesized glyceride copolymer was prepared by charging canola oil (7500 g) to a 10 liter glass reactor. The canola oil was pre-treated by sparging with nitrogen while heating to 200° C. for a hold time of 2 hours. The canola oil was cooled to room temperature and stirred with nitrogen sparge overnight. The pre-treated canola oil was then heated to 95° C. followed by the addition of a toluene solution of C827 metathesis catalyst (25 ppm catalyst relative to weight of oil). Vacuum was applied to 20 Torr with stirring for 1 hour. Vacuum was broken with an additional toluene solution of C827 metathesis catalyst (25 ppm catalyst relative to weight of oil—50 ppm total catalyst) followed by stirring under vacuum for 1 hour. The temperature of the reaction was raised to 180° C. with stirring for 1 hour, under vacuum. The reaction was cooled to 95° C. under vacuum followed by the addition of a toluene solution of C827 metathesis catalyst (25 ppm catalyst relative to weight of oil ˜75 ppm total catalyst) and stirring for 1 hour followed by the addition of a toluene solution of C827 metathesis catalyst (25 ppm catalyst relative to weight of oil ˜100 ppm total catalyst) and stirring for 1 hour. The reaction was kept under a nitrogen sparge while cooling to room temperature overnight. The reaction mixture was warmed to 85° C. followed by addition of THMP (5 molar equivalents relative to the total catalyst added) and stirring for 2 hours. The reaction mixture was cooled and discharged into buckets.

TABLE 3

| | | Target | Total catalyst | Final glyceride |
|---|---|---|---|---|
| Example | Reactor size | Vacuum | (ppm) | copolymer Mw |
| B1 | 2 liter | 20 Torr | 100 ppm | 15,650 |
| B2 | 2 liter | 20 Torr | 100 ppm | 16,166 |
| B3 | 2 liter | 20 Torr | 100 ppm | 13,188 |
| B4 | 10 liter | 20 Torr | 100 ppm | 12,978 |

### Example B6—Batch Process with Overnight Hold and THMP

Self-metathesized glyceride copolymer was prepared by charging canola oil (1000 g) to a 2 liter glass reactor. The canola oil was then heated to 95° C. followed by the addition of a toluene solution of C827 metathesis catalyst (25 ppm catalyst relative to weight of oil). Vacuum was applied to 20 Torr with stirring for 1 hour. Vacuum was broken with an additional toluene solution of C827 metathesis catalyst (25 ppm catalyst relative to weight of oil—50 ppm total catalyst) followed by stirring under vacuum for 1 hour. The temperature of the reaction was raised to 180° C. with stirring for 1 hour, under vacuum (20 torr). The reaction was cooled to 95° C. under vacuum followed by the addition of a toluene solution of C827 metathesis catalyst (25 ppm catalyst relative to weight of oil—75 ppm total catalyst) and stirring for 1 hour followed by the addition of a toluene solution of C827 metathesis catalyst (25 ppm catalyst relative to weight of oil—100 ppm total catalyst) and stirring for 1 hour, under 20 torr vacuum. The reaction was kept under a nitrogen sparge at 95° C. overnight. The reaction mixture was cooled to 80° C. followed by addition of THMP (25 molar equivalents relative to the total catalyst added) and stirring for 2 hours. The reaction mixture was cooled and discharged. Further information is set forth in Table 4.

### Example B7—Batch Process with Heating/Cooling

The process of Example B6 was carried out as set forth above, except that a N₂ sparge instead of vacuum was used for the first 75 ppm catalyst addition. A vacuum of 20 Torr was used while the temperature was increased to 180° C. and for the last addition of 25 ppm of catalyst (total catalyst addition of 100 ppm). Further information is set forth in Table 4.

### Example B8—Batch Process with Heating/Cooling

The process of Example B6 was carried out as set forth above, except that the experiment was performed in a 2 L kettle flask and an additional 25 ppm catalyst was added (total catalyst of 125 ppm) followed by stirring for 1 hour. Further information is set forth in Table 4.

### Example B9—Batch Process with Heating/Cooling

The process of Example B6 was carried out as set forth above, except that the experiment was performed in a 2 L kettle flask and the temperature was raised to 200° C. instead of 180° C. followed by stirring for 1 hour. Further information is set forth in Table 4.

TABLE 4

| | Reactor | | Total catalyst | Final glyceride |
|---|---|---|---|---|
| Example | size | Target Vacuum | (ppm) | copolymer Mw |
| B6 | 2 liter | 20 Torr | 100 ppm | 12,500 |
| B7 | 2 liter | N₂ sparge/20 Torr | 100 ppm | 11,554 |
| B8 | 2 liter | 20 Torr | 125 ppm | 11,488 |
| B9 | 2 liter | 20 Torr | 100 ppm | 11,958 |

### Example C—Self Metathesis with Batched Catalyst Introduction—2 L Scale

### Example C1—Batch Process with No Overnight Hold

Self-metathesized glyceride copolymer was prepared by charging canola oil (1000 g) to a 2 liter glass reactor. The canola oil was then heated to 95° C. under a stream of nitrogen followed by the addition of a toluene solution of C827 metathesis catalyst (25 ppm catalyst relative to weight of oil) and stirring for 1 hour. Catalyst was added in 1 hour increments (25 ppm) for a total of 100 ppm catalyst added. The reaction was cooled and discharged. Further details are provided in Table 5.

### Example C2—Batch Process with No Overnight Hold

The process of Example C1 was carried out as set forth above, except that catalyst added 25 ppm at 30 minute intervals rather than 1 hour. Further information is set forth in Table 5.

TABLE 5

| | | Total | | THMP | |
|---|---|---|---|---|---|
| | Reactor | catalyst | WFE | added | Final glyceride |
| Example | size | (ppm) | (Y/N) | (Y/N) | copolymer Mw |
| C1 | 2 liter | 100 ppm | N | N | 11,405 |
| C2 | 2 liter | 100 ppm | N | N | 10,929 |

### Example C3—Batch Process with Overnight Hold

Self-metathesized glyceride copolymer was prepared by charging canola oil (500 g) to a 1 liter glass reactor. The canola oil was then heated to 95° C. under a stream of nitrogen followed by the addition of a toluene solution of C827 metathesis catalyst (25 ppm catalyst relative to weight of oil) and stirring for 1 hour. An additional toluene solution of C827 metathesis catalyst (25 ppm catalyst relative to weight of oil—50 ppm total catalyst) was added followed by stirring under nitrogen at 95° C. overnight. An additional toluene solution of C827 metathesis catalyst (25 ppm catalyst relative to weight of oil—75 ppm total catalyst) was added with stirring for 1 hour followed by the addition of a toluene solution of C827 metathesis catalyst (25 ppm catalyst relative to weight of oil—100 ppm total catalyst) and stirring for 1 hour (total reaction time—24 hours). The reaction was cooled and discharged. Further information is set forth in Table 6.

### Example C4—Batch Process with No Overnight Hold

The process of Example C1 was carried out as set forth above. Further information is set forth in Table 6.

TABLE 6

| | | Total | | THMP | |
|---|---|---|---|---|---|
| | Reactor | catalyst | WFE | added | Final glyceride |
| Example | size | (ppm) | (Y/N) | (Y/N) | copolymer Mw |
| C3 | 2 liter | 100 ppm | N | N | 16,262 |
| C4 | 2 liter | 100 ppm | N | N | 16,263 |

### Example D—Olefin Stripping

Crude glyceride copolymer is charged to the WFE feed flask and processed at a temperature set point of 180° C., 200° C., 230° C., or 245° C. at full vacuum (Welch belt drive pump) to separate the reaction olefins from the desired glyceride copolymer.

Example D1—The copolymer of Example B1 is stripped using a wipe film evaporator (WFE). Crude glyceride copolymer is charged to the WFE feed flask and is processed at a temperature set point of 180° C. at full vacuum (Welch belt drive pump) with a flow rate of approximately 3.5 mL/min to separate the reaction olefins from the desired glyceride copolymer. The stripped glyceride copolymer is cooled and discharged into buckets.

Example D2—The glyceride copolymer of Example A2 is stripped using a wipe film evaporator (WFE). Crude glyceride copolymer is charged to the WFE feed flask and is processed at a temperature set point of 245° C. at full vacuum (Welch belt drive pump) with a flow rate of approximately 3.5 mL/min to separate the reaction olefins from the desired glyceride copolymer. The stripped glyceride copolymer is cooled and discharged into buckets.

Example D3—The glyceride copolymer of Example A4 is stripped using a wipe film evaporator (WFE). Crude glyceride copolymer is charged to the WFE feed flask and is processed at a temperature set point of 230° C. at full vacuum (Welch belt drive pump) with a flow rate of approximately 3.5 mL/min to separate the reaction olefins from the desired glyceride copolymer. The stripped glyceride copolymer is cooled and discharged into buckets.

Example D4—The glyceride copolymer of Example B3 is stripped using a wipe film evaporator (WFE). Crude glyceride copolymer is charged to the WFE feed flask and is processed at a temperature set point of 200° C. at full vacuum (Welch belt drive pump) with a flow rate of approximately 3.5 mL/min to separate the reaction olefins from the desired glyceride copolymer. The stripped glyceride copolymer is cooled and discharged into buckets.

### Comparative Examples

Comparative Glyceride Copolymer #1

Canola oil (3000 g; catalog # S1100-P; lot #30315, J. Edwards International, Inc., Braintree, Mass.) is added to a 5 L flask equipped with mechanical, overhead stirring, a thermocouple, and a nitrogen gas sparging tube. The oil is mixed with sub-surface sparging for 30 mins, then heated to 200° C. for 2 hours. The oil is cooled overnight while maintaining a nitrogen blanket.

The oil is heated to 60° C. and a catalyst solution containing 0.15 g (50 ppm, catalyst weight/total oil weight) of dichloro[1,3-bis(2,4,6-trimethylphenyl)-2-imidazolidinylidene](3-methyl-2-butenylidene) (tricyclohexylphosphine)ruthenium(II) (CAS # [253688-91-4], C827, lot #2812, Materia Inc., Pasadena Calif.) dissolved in 20 mL toluene (CAS #[108-88-3], EMD Millipore Inc., Burlington, Mass.) dried/stored over molecular sieves) is added to the heating, stirring oil. After 4 hours, 0.22 g (10× mol/mol Ru) of tris(hydroxymethyl) phosphine (CAS #[2767-80-8], catalog #177881, lot # BGBC5027V, Sigma-Aldrich Inc., Milwaukee Wis.) is added and stirred one additional hour. The oil is cooled and transferred batch-wise (3 portions) to a wipe-film evaporator where olefin is removed at 180° C., 0.13-0.14 Torr, at 110 rpm with a delivery flow rate of −110-160 g/hour. The composite material from all 3 portions is 2650 g.

Comparative Glyceride Copolymer #2

Canola oil (1700 g; catalog # S1100-P; lot #30315, J. Edwards International, Inc., Braintree, Mass.) and Butenolyzed Canola Oil (800 g) are provided.

The Butenolyzed Canola Oil is prepared as follows. Canola oil (8.24 kg) is charged to a 20 liter stainless steel Parr reactor and pre-treated by sub-surface nitrogen sparge and stirring at 25° C. for 15 minutes and then at 200° C. for 2 hours. The pretreated canola oil is cooled to 65° C. while continuing the sub-surface nitrogen sparge overnight. The nitrogen sparge is stopped and 1-butene (2.08 kg, Mattheson Lot #1023110467A) is added to the pre-treated canola oil at 65° C. The reaction is initiated by the addition of C827 metathesis catalyst (332 mg dissolved in 60 mL of p-xylene) and continues for 3 hours at 65° C. with stirring. Then, light olefins are removed from the reaction by sub-surface nitrogen sparge at 65° C. for 1 hour. Light olefins from the sparge are condensed in an inline trap cooled by dry ice/isopropanol. The amount of light olefins collected is 0.54 kg. The contents of the reactor are cooled to 35° C. before being drained to a separate collection vessel. The yield of crude butenolyzed canola oil is 8.78 kg.

Crude butenolyzed canola oil (7.41 kg) from the previous step is charged to a 12 L, 4-neck round bottom flask equipped with an overhead mechanical stirrer, thermowell, and simple distillation head. Aqueous THMP solution (0.12 M, 84 mL) is added and the mixture is heated to 70° C. and stirred for one hour to quench the catalyst. Water and olefins are removed by gradually applying vacuum to the flask and then slowly increasing temperature while stirring the mixture. The final temperature of 210° C. and pressure of 15 torr is maintained for 1 hour. The yield of butenolyzed canola oil is 5.08 kg. The distillate consists of 2.02 kg of mixed olefins and 67 g of water.

The canola oil and Butenolyzed Canola Oil are added to a 5 L flask equipped with mechanical, overhead stirring, a thermocouple, and a nitrogen gas sparging tube. The oil mixture is mixed with sub-surface sparging for 1 hour, then heated to 200° C. for 2 hours. The oil mixture is cooled overnight while maintaining a nitrogen blanket.

The oil mixture is heated to 84° C. and a catalyst solution containing 0.125 g (50 ppm, catalyst weight/total oil weight) of dichloro[1,3-bis(2,4,6-trimethylphenyl)-2-imidazolidinylidene](3-methyl-2-butenylidene) (tricyclohexylphosphine)ruthenium(II) (CAS # [253688-91-4], C827, lot #2812, Materia Inc., Pasadena Calif.) dissolved in 15 mL toluene (CAS # [108-88-3], EMD Millipore Inc., Burlington, Mass.) dried/stored over molecular sieves) is added to the heating, stirring oil. A vacuum of 450 Torr is applied to the flask. After 5 hours, 0.55 g (25× mol/mol Ru) of tris(hydroxymethyl) phosphine (CAS # [2767-80-8], catalog #177881, lot # BGBC5027V, Sigma-Aldrich Inc., Milwaukee Wis.) is added and stirred one-to-two hours at 80° C. The oil is cooled and stored until processed via wipe-film evaporator.

The metathesized oil is processed through a wipe-film evaporator where olefin was removed at 179-181° C., 10-12 Torr, at 110 rpm with a delivery flow rate of 180 g/hour.

### Example E—Exemplary Liquid Fabric Enhancer Formulations

Liquid fabric enhancer (LFE) products according to the following examples in Table 7 may be prepared. Examples E1, E2, E5, E6, and E7 are compositions according to the present disclosure, and Examples E3 and E4 are comparative compositions. Examples E1-E4 are used in the z-nose tests described below, and Examples E5-E7 are used in the friction tests described below.

TABLE 7

| | Examples | | | | | | |
|---|---|---|---|---|---|---|---|
| | LFE for z-nose tests | | | | LFE for friction tests | | |
| | E1 | E2 | E3 | E4 | E5 | E6 | E7 |
| Ingredients | (inv.) | (inv.) | (comp.) | (comp.) | (inv.) | (inv.) | (inv.) |
| Fabric Softener | 8.6 | 8.6 | 8.6 | 8.6 | 8.5 | 8.5 | 8.5 |
| Active¹ | | | | | | | |
| Low molecular | 0.9 | 0.9 | 0.9 | 0.9 | 0.9 | 0.9 | 0.9 |
| weight alcohol² | | | | | | | |
| Calcium chloride | 0-0.3 | 0-0.3 | 0-0.3 | 0-0.3 | 0-0.3 | 0-0.3 | 0-0.3 |
| Quatemized | 0.14 | 0.14 | 0.14 | 0.14 | 0.14 | 0.14 | 0.14 |
| polyacrylamide³ | | | | | | | |
| Glyceride | 4.2 | 0.0 | 0.0 | 0.0 | 4.2 | 0.0 | 0.0 |
| copolymer from | | | | | | | |
| Example D1 (inv.) | | | | | | | |
| Glyceride | 0.0 | 4.2 | 0.0 | 0.0 | 0.0 | 4.2 | 0.0 |
| copolymer from | | | | | | | |
| Example D2 (inv.) | | | | | | | |
| Glyceride | 0.0 | 0.0 | 0.0 | 0.0 | 0.0 | 0.0 | 4.2 |
| copolymer from | | | | | | | |
| Example D3 (inv.) | | | | | | | |
| Comparative | 0.0 | 0.0 | 4.2 | 0.0 | 0.0 | 0.0 | 0.0 |
| Glyceride | | | | | | | |
| Copolymer #1 | | | | | | | |
| (comp.) | | | | | | | |
| Comparative | 0.0 | 0.0 | 0.0 | 4.2 | 0.0 | 0.0 | 0.0 |
| Glyceride | | | | | | | |
| Copolymer #2 | | | | | | | |
| (comp.) | | | | | | | |
| Cetyl trimethyl | 0.42 | 0.42 | 0.42 | 0.42 | 0.42 | 0.42 | 0.42 |
| ammonium | | | | | | | |
| chloride⁴ | | | | | | | |
| Perfume | — | — | — | — | 1.57 | 1.57 | 1.57 |
| Perfume | — | — | — | — | 0.25 | 0.25 | 0.25 |
| microcapsule⁵ | | | | | | | |
| Water, emulsifiers, | q.s. to | q.s. to | q.s. to | q.s. to | q.s. to | q.s. to | q.s. to |
| suds suppressor, | 100% | 100% | 100% | 100% | 100% | 100% | 100% |
| stabilizers, | pH = 3.0 | pH = 3.0 | pH = 3.0 | pH = 3.0 | pH = 3.0 | pH = 3.0 | pH = 3.0 |
| preservative, | | | | | | | |
| antioxidant, | | | | | | | |
| chelant, pH control | | | | | | | |
| agents, buffers, | | | | | | | |
| dyes & other | | | | | | | |
| optional | | | | | | | |
| ingredients | | | | | | | |

¹N,N-di(alkanoyloxyethyl)-N,N-dimethylammonium chloride where alkyl consists predominantly of C16-C18 alkyl chains with an IV value of about 20 available from Evonik. Contains a trace amount of coco oil.
²Low molecular weight alcohol such as ethanol or isopropanol
³Cationic polyacrylamide polymer such as a copolymer of acrylamide/[2-(acryloylamino)ethyl]tri-methylammonium chloride (quaternized dimethyl aminoethyl acrylate) available from BASF, AG, Ludwigshafen under the trade name Rheovis CDX.
⁴Didecyl dimethyl ammonium chloride under the trade name Bardac ® 2280 or Hydrogenated tallowalkyl(2-ethylhexyl)dimethyl ammonium methylsulfate from AkzoNobel under the trade name Arquad ®HTL8-MS
⁵Perfume microcapsules available ex Appleton Papers, Inc.

### Example F—Intensity Reduction

Four unperfumed liquid fabric enhancer (LFE) products are prepared. Examples E1 and E2 each include a glyceride copolymer according to the present disclosure. Examples E3 and E4 each include a comparative glyceride copolymer. Headspace intensity of peaks, if present, at certain Kovats Index (KI) values or intervals is measured on the neat liquid fabric enhancer product according to the z-nose method provided above; the results are provided in Table 8. Peaks which are not detected at a given KI or given KI interval are shown in the table as a zero intensity. A sum of all peaks is also calculated and provided in Table 8. A student t-test is run using JMP® Pro software (version 13.2.1, available from SAS Institute Inc.) to compare values, with the letters from the connected letter report shown in parenthesis. Values not connected by the same letter are significantly different.

TABLE 8

| | F1 | F2 | F3 | F4 |
|---|---|---|---|---|
| Example | (inv.) | (inv.) | (comp.) | (comp.) |
| Description | Example E1 | Example E2 | Example E3 | Example E4 |
| | with Glyceride | with Glyceride | with | with |
| | copolymer of | copolymer of | Comparative | Comparative |
| | Example D1 | Example D2 | Glyceride | Glyceride |
| | (inv.) | (inv.) | Copolymer #1 | Copolymer #2 |
| | | | (comp.) | Glyceride |
| | | | | (comp.) |
| Intensity at KI 609 | 0 ± 0 (b) | 0 ± 0 (b) | 0 ± 0 (b) | 636 ± 78 (a) |
| Intensity at KI 668 | 0 ± 0 (c) | 0 ± 0 (c) | 1290 ± 34 (a) | 596 ± 128 (b) |
| Intensity at KI 800 | 0 ± 0 (c) | 0 ± 0 (c) | 792 ± 26 (a) | 321 ± 76 (b) |
| Intensity between | 864 ± 12 (b) | 996 ± 6 (b) | 1270 ± 75 (a) | 1498 ± 168 (a) |
| KI 900-903 | | | | |
| Intensity at KI 1000 | 744 ± 0 (bc) | 725 ± 1 (c) | 850 ± 88 (ab) | 879 ± 12 (a) |
| Intensity at KI 1094 | 0 ± 0 (b) | 0 ± 0 (b) | 587 ± 13 (a) | 0 ± 0 (b) |
| Intensity between | 377 ± 97 (a) | 0 ± 0 (b) | 0 ± 0 (b) | 0 ± 0 (b) |
| KI 1378-1380 | | | | |
| Sum of all peaks | 3091 ± 214 (c) | 2891 ± 93 (c) | 5982 ± 244 (a) | 5024 ± 483 (b) |

According to the results shown in Table 8, a fabric composition made according to Example E1 or E2 shows peaks indicating less, or even zero, intensity at the provided KI values or KI intervals. (Peaks, if present, at other KI values or KI intervals were substantially the same for both legs of the experiment.) The difference indicates that the tested materials are chemically different, and that a material according to the present disclosure provides less intensity for at least some intervals compared to the comparative materials. Without wishing to be bound by theory, the fabric compositions containing the comparative glyceride copolymers show peak intensities at KI values corresponding to low molecular weight olefins, whereas these peaks corresponding to low molecular weight olefins are absent for fabric compositions made with materials of the present disclosure. This suggests that the materials of the present disclosure provide less intensity overall and may be more desirable for incorporation into a perfumed product or even an unscented product.

### Example G—Softness Test

Without being bound by theory, it is believed that fabric friction is a technical measure of fabric softness. To test whether materials according to the present disclosure provide a softness effect to fabrics, 100% cotton terry washcloths (China 2, available from Standard Textiles) are laundered using a top load automatic laundry machine (Kenmore 600 Series) and electric dryer (Maytag Commercial Stackable Dryer). The water temperature is set to 90° F. during the wash cycle and 60° F. during the rinse cycle. Ten 100% cotton terry washcloths weighing around 56.5 g each (China 2, available from Standard Textiles), are added to the washing machine along with a ballast of pillow cases (60% cotton/40% polyester), T-shirts (cotton, polyester, and poly-cotton), and fabric swatches (cotton and poly-cotton). The total weight of fabrics added to the washing machine is 2500±20 grams. The 49.6 gram dose of liquid detergent (TIDE® Original Scent, ex The Procter & Gamble Company) is added to 17 gallons of 8-9 GPG water (grains per gallons) and the wash time is set to 12 min.

Following the wash treatment, the fabrics are treated with 25.5 g of a liquid fabric enhancer product through the rinse. The rinse time is set to 2 min and the fabrics are tumble dried for 50 minutes on high heat. This wash, rinse, and drying procedure is repeated 3 times for the fabric load.

For examples G1, G2, and G3, the liquid fabric enhancer products are compositions according to the present disclosure (see examples E5, E6, and E7 provided above).

As a comparative example (G4), terry towel washcloths are similarly treated, but instead using liquid DOWNY® (ex The Procter & Gamble Company) as the liquid fabric enhancer product added in the rinse.

Following treatment, the kinetic coefficient of friction of the treated washcloths is determined according to the friction method described above. Results are shown in Table 9. A relatively lower kinetic coefficient of friction is indicative of a smoother/softer surface, and values not connected by same letter are significantly different.

TABLE 9

| | | Kinetic Coefficient |
|---|---|---|
| Example | Rinse Treatment | of Friction |
| G1 | Example E5 with Glyceride | 1.18 ± 0.03 (c) |
| | copolymer of Example D1 | |
| G2 | Example E6 with Glyceride | 1.31 ± 0.05 (b) |
| | copolymer of Example D2 | |
| G3 | Example E7 with Glyceride | 1.16 ± 0.07 (c) |
| | copolymer of Example D3 | |
| G4 (comp.) | Liquid DOWNY ® | 1.52 ± 0.04 (a) |

As shown in Table 9, terry towels treated with a composition according to Examples G1, G2, or G3 have a significantly lower coefficient of friction than similar towels treated with liquid DOWNY®, indicating superior softness performance of Examples G1, G2, and G3.

The dimensions and values disclosed herein are not to be understood as being strictly limited to the exact numerical values recited. Instead, unless otherwise specified, each such dimension is intended to mean both the recited value and a functionally equivalent range surrounding that value. For example, a dimension disclosed as “40 mm” is intended to mean “about 40 mm”

Every document cited herein, including any cross referenced or related patent or application and any patent application or patent to which this application claims priority or benefit thereof, is hereby incorporated herein by reference in its entirety unless expressly excluded or otherwise limited. The citation of any document is not an admission that it is prior art with respect to any invention disclosed or claimed herein or that it alone, or in any combination with any other reference or references, teaches, suggests or discloses any such invention. Further, to the extent that any meaning or definition of a term in this document conflicts with any meaning or definition of the same term in a document incorporated by reference, the meaning or definition assigned to that term in this document shall govern.

While particular embodiments of the present invention have been illustrated and described, it would be obvious to those skilled in the art that various other changes and modifications can be made without departing from the spirit and scope of the invention. It is therefore intended to cover in the appended claims all such changes and modifications that are within the scope of this invention.

What is claimed is:

1. A fabric care composition comprising:
an adjunct material, and
a glyceride polymer obtainable by a process comprising the steps of:
(a) providing a reaction mixture comprising unsaturated natural oil glycerides;
(b) introducing a first quantity of a first olefin metathesis catalyst to the reaction mixture to react the unsaturated natural oil glycerides and form a first product mixture comprising unreacted unsaturated natural oil glycerides, first oligomerized unsaturated natural oil glycerides, and a first olefin byproduct; and
(c) introducing a second quantity of a second olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct.

2. The fabric care composition according to claim 1, wherein second product mixture further comprises unreacted unsaturated natural oil glycerides, and further comprising introducing a third quantity of a third olefin metathesis catalyst to the second product mixture to react the unreacted unsaturated natural oil glycerides and the second oligomerized unsaturated natural oil glycerides and form a third product mixture comprising third oligomerized unsaturated natural oil glycerides and a third olefin byproduct,
optionally, wherein the third product mixture further comprises unreacted unsaturated natural oil glycerides, and further comprising introducing a fourth quantity of a fourth olefin metathesis catalyst to the third product mixture to react the unreacted unsaturated natural oil glycerides and the third oligomerized unsaturated natural oil glycerides and form a fourth product mixture comprising fourth oligomerized unsaturated natural oil glycerides and a fourth olefin byproduct,
optionally, wherein the fourth product mixture further comprises unreacted unsaturated natural oil glycerides, and further comprising introducing a fifth quantity of a fifth olefin metathesis catalyst to the fourth product mixture to react the unreacted unsaturated natural oil glycerides and the fourth oligomerized unsaturated natural oil glycerides and form a fifth product mixture comprising fifth oligomerized unsaturated natural oil glycerides and a fifth olefin byproduct.

3. The fabric care composition according to claim 1, wherein the unsaturated natural oil glycerides comprise glycerides of unsaturated fatty acids selected from the group consisting of: oleic acid, linoleic acid, linolenic acid, vaccenic acid, 9-decenoic acid, 9-undecenoic acid, 9-dodecenoic acid, 9,12-tridecadienoic acid, 9,12-tetradecadienoic acid, 9,12-pentadecadienoic acid, 9,12,15-hexadecatrienoic acid, 9,12,15 heptadecatrienoic acid, 9,12,15-octadecatrienoic acid, 11-dodecenoic acid, 11-tridecenoic acid, and 11-tetradecenoic acid.

4. The fabric care composition according to claim 1, wherein the unsaturated natural oil glycerides are derived from a vegetable oil, optionally wherein the vegetable oil is selected from the group consisting of rapeseed oil, canola oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, or any combination thereof.

5. The fabric care composition according to claim 1, wherein at least two of the first olefin metathesis catalyst, the second olefin metathesis catalyst, the third olefin metathesis catalyst if present, the fourth olefin metathesis catalyst if present, and/or the fifth olefin metathesis catalyst if present, are the same catalyst.

6. The fabric care composition according to claim 1, wherein the glyceride polymer has a weight average molecular weight (M_{w}) ranging from 4,000 g/mol to 150,000 g/mol.

7. The fabric care composition according to claim 1, further comprising one or more of:
removing at least a portion of the first olefin byproduct from the first product mixture;
removing at least a portion of the second olefin byproduct from the second product mixture;
removing at least a portion of the third olefin byproduct from the third product mixture;
removing at least a portion of the fourth olefin byproduct from the fourth product mixture; or
removing at least a portion of the fifth olefin byproduct from the fifth product mixture.

8. The fabric care composition of claim 1, wherein the olefin metathesis reaction(s) that generate the first product mixture, the second product mixture, the third product mixture, the fourth product mixture, and/or the fifth product mixture, is/are carried out at a temperature of no more than 180° C., and at vacuum conditions from about 10 to about 300 mm Hg.

9. The fabric care composition according to claim 1, wherein the method further comprises at least one of:
isomerizing the second oligomerized unsaturated natural oil glycerides;
isomerizing the third oligomerized unsaturated natural oil glycerides; or
isomerizing the fourth oligomerized unsaturated natural oil glycerides.

10. The fabric care composition according to claim 1, wherein the isomerizing step(s) comprise heating the first product mixture, the second product mixture, the third product mixture, and/or the fourth product mixture,
wherein the heating is to a temperature of at least 150° C., under vacuum conditions from about 10 to about 300 mm Hg.

11. The fabric care composition according to claim 1, wherein the composition comprises from about 0.1% to about 50%, by weight of the composition, of the glyceride polymer.

12. The fabric care composition according to claim 1, wherein the adjunct material is selected from: bleach activators, surfactants, delivery enhancing agents, builders, chelating agents, dye transfer inhibiting agents, dispersants, enzymes, and enzyme stabilizers, catalytic metal complexes, polymeric dispersing agents, clay and soil removal/anti-redeposition agents, brighteners, suds suppressors, dyes, additional perfumes and perfume delivery systems, structure elasticizing agents, fabric conditioning actives (FCAs), anionic surfactant scavengers, carriers, hydrotropes, processing aids, structurants, anti-agglomeration agents, coatings, formaldehyde scavengers, pigments, a deposition aid, an emulsifier, and mixtures thereof.

13. The fabric care composition according to claim 1, wherein the adjunct material comprises at least one of the following:
a) a fabric conditioning active (FCA);
b) perfume and/or a perfume delivery system; or
c) a structurant.

14. The fabric care composition according to claim 1, wherein the fabric care composition is in the form of a liquid composition, a granular composition, a single-compartment pouch, a multi-compartment pouch, a dissolvable sheet, a pastille, a fibrous article, a tablet, a bar, a flake, a foam, a non-woven sheet, or a mixture thereof.

15. The fabric care composition according to claim 14, wherein the fabric care composition is in the form of a liquid composition.

16. The fabric care composition according to claim 1, wherein the fabric care composition is a fabric enhancer composition.

17. A fabric care composition comprising:
an adjunct material, and
a glyceride polymer obtainable by a process comprising the steps of:
(a) providing a reaction mixture comprising unsaturated natural oil glycerides, and, optionally, initial oligomerized unsaturated natural oil glycerides;
(b) introducing a first quantity of a first olefin metathesis catalyst to the reaction mixture to react the unsaturated natural oil glycerides and, optionally, the initial oligomerized unsaturated natural oil glycerides, and form a first product mixture comprising unreacted unsaturated natural oil glycerides, first oligomerized unsaturated natural oil glycerides, and a first olefin byproduct; and
(c) introducing a second quantity of a second olefin metathesis catalyst to the first product mixture to react the unreacted unsaturated natural oil glycerides and the first oligomerized unsaturated natural oil glycerides and form a second product mixture comprising second oligomerized unsaturated natural oil glycerides and a second olefin byproduct;
wherein the method comprises isomerizing the first oligomerized unsaturated natural oil glycerides.

18. The fabric care composition according to claim 17, wherein second product mixture further comprises unreacted unsaturated natural oil glycerides, and further comprising introducing a third quantity of a third olefin metathesis catalyst to the second product mixture to react the unreacted unsaturated natural oil glycerides and the second oligomerized unsaturated natural oil glycerides and form a third product mixture comprising third oligomerized unsaturated natural oil glycerides and a third olefin byproduct,
optionally, wherein the third product mixture further comprises unreacted unsaturated natural oil glycerides, and further comprising introducing a fourth quantity of a fourth olefin metathesis catalyst to the third product mixture to react the unreacted unsaturated natural oil glycerides and the third oligomerized unsaturated natural oil glycerides and form a fourth product mixture comprising fourth oligomerized unsaturated natural oil glycerides and a fourth olefin byproduct,
optionally, wherein the fourth product mixture further comprises unreacted unsaturated natural oil glycerides, and further comprising introducing a fifth quantity of a fifth olefin metathesis catalyst to the fourth product mixture to react the unreacted unsaturated natural oil glycerides and the fourth oligomerized unsaturated natural oil glycerides and form a fifth product mixture comprising fifth oligomerized unsaturated natural oil glycerides and a fifth olefin byproduct.

19. The fabric care composition according to claim 17, wherein the unsaturated natural oil glycerides are derived from a vegetable oil, optionally wherein the vegetable oil is selected from the group consisting of rapeseed oil, canola oil, coconut oil, corn oil, cottonseed oil, olive oil, palm oil, peanut oil, safflower oil, sesame oil, soybean oil, sunflower oil, linseed oil, palm kernel oil, tung oil, jatropha oil, mustard seed oil, pennycress oil, camelina oil, hempseed oil, castor oil, or any combination thereof.

20. The fabric care composition according to claim 17, wherein the fabric care composition is a liquid fabric enhancer composition.
